(19) United States
(12) Patent Application Publication
(10) Pub. No.: US 2012/0139975 A1
(43) Pub. Date: Jun. 7, 2012

(54) Display Device

(75) Inventors: Katsuteru Hashimoto, Osaka (JP); Kohji Fujiwara, Osaka (JP); Kingfoong Lew, Osaka (JP); Katsuya Otoi, Osaka (JP)

(73) Assignee: SHARP KABUSHIKI KAISHA, Osaka-shi, Osaka (JP)

(21) Appl. No.: 13/389,822

(22) PCT Filed: May 13, 2010
(86) PCT No.: PCT/JP2010/058087

§ 371 Date: Feb. 10, 2012

(30) Foreign Application Priority Data
Sep. 9, 2009 (JP) 2009-208602

(51) Int. Cl. G09G 5/10

(52) U.S. Cl. 345/690

(57) ABSTRACT

Disclosed is a display device that has improved correspondence between brightness distribution of an illuminating device including a plurality of partial lights and brightness distribution of images displayed on a display panel. Specifically, in a liquid crystal display, a filtering unit generates brightness distribution data by filtering each item of brightness adjustment data corresponding to partial lights using a filter among a plurality of brightness diffusing filters. Furthermore, a panel control data correcting unit generates panel control data that controls images displayed on a liquid crystal display panel from the brightness distribution data and panel control data.

### TECHNICAL FIELD

The present invention relates to a display device such as, for example, a liquid crystal display device.

### BACKGROUND ART

In a liquid crystal display device (display device) that incorporates a liquid crystal display panel (display panel) of non-light emitting type, usually, a backlight unit (illumination device) for supplying light to the liquid crystal display panel also is incorporated. In such display unit, it is desirable that brightness of output light (backlight) from the backlight unit changes in accordance with a display image on the liquid crystal display panel.

For example, in a case where the display image is a black image, if the brightness of the backlight supplied to a portion (display region) of the display panel that displays the black image is high, a waste occurs in drive electric power for the backlight unit, further, quality of the black image also becomes low.

Accordingly, recently, a backlight unit is developed, which has a local dimming function that is capable of partially controlling the brightness of the backlight (e.g., a patent document 1). Such backlight unit is capable of curbing the brightness only of local light (partial light) of the backlight supplied to a portion of a display panel that display a black image compared with the brightness of light at another portion. Because of this, a liquid crystal display device incorporating such backlight unit is capable of providing a high-quality display image while curbing electric power consumption.

### Citation List

### Patent Literature

PLT1: JP-A-2007-34251

### SUMMARY OF INVENTION

### Technical Problem

However, the number of pieces of partial light included in backlight unit light is usually smaller than the number of pixels of a liquid crystal display panel. Because of this, one piece of partial light shines onto a display region that includes a plurality of pixels. Accordingly, correspondence between a brightness distribution of the backlight including a plurality of pieces of partial light and a brightness distribution of the display image on the liquid crystal display panel is a key to provision of a high-quality display image.

The present invention has been made to solve the above problems. And, it is an object of the present invention to provide a display device that improves correspondence between a brightness distribution of backlight including a plurality of pieces of partial light and a brightness distribution of a display image on a display panel, thereby displaying a high-quality display image.

### Solution to Problem

The display device includes: an illumination device that generates output light by mixing light source light from a plurality of light sources; a display panel that receives the output light; and a control unit that controls the illumination device and the display panel. And, in this display device, the control unit includes: an image data process portion; a brightness adjustment data generation portion; a filter process portion; and a panel control data correction portion.

The image data process portion obtains image data and generates, from the image data, light source control data and panel control data. The brightness adjustment data generation portion processes the light source control data in accordance with each piece of partial light, that is, local light included in the output light from the illumination device so as to generate brightness adjustment data for controlling brightness of the light source.

The filter process portion processes each of the brightness adjustment data that corresponds to each piece of the partial light by means of one of a plurality of brightness distribution filters so as to generate brightness distribution data of the output light, there are many kinds of brightness distributions of the plurality of pieces of the partial light due to the light source. The panel control data correction portion, from the brightness distribution data and the panel control data, generates correction panel control data for controlling a display image on the display panel.

According to such display device, the filter process portion, in accordance with the partial light, generates the brightness distribution data of the output light from the illumination device by means of the most suitable brightness distribution filter of the plurality of the brightness distribution filters. Because of this, the brightness distribution data becomes exact data that reflects interference and the like of each piece of the partial light. Further, the correction panel control data is obtained from the exact brightness distribution data given by processing the brightness adjustment data by means of the plurality of brightness distribution filters. Because of this, the correction panel control data exactly reflects the brightness adjustment data.

Accordingly, in a case where correspondence between the brightness adjustment data relating to the brightness of the light source and the data (the correction panel control data) relating to the display image on the display panel influences quality of the display image on the display device, accuracy of the correspondence improves. Accordingly, the quality of the display image on the liquid crystal display device surely improves.

Here, as an example in which there are many kinds of brightness distributions of the plurality of pieces of partial light due to the light source, there is an example in which a plurality of the light sources having different inherent brightness distributions are included, whereby there are many kinds of the brightness distributions of the plurality of pieces of partial light.

Here, as an example of a difference in the inherent brightness distributions, there is an example in which the inherent brightness distribution depends on whether the light source is a power light emitting element or not. Besides, as another example, there is an example, in which the inherent brightness distribution depends on whether the light source emits white light obtained by mixing light from a plurality of incorporated light emitting chips that emit single color light or emits white light obtained by mixing the light from the incorporated light emitting chip and light from a fluorescent-light emitting body that receives the light from the light emitting chip to emit fluorescent light.

Besides, as an example in which there are the many kinds of brightness distributions of the plurality of pieces of partial light due to the light source, there is an example, in which there is a difference in light-source density of the plurality of light sources, whereby there are the many kinds of brightness distributions of the plurality of pieces of partial light.

Besides, as an example in which there are the many kinds of brightness distributions of the plurality of pieces of partial light due to the light source, there is an example, in which the plurality of light sources emitting the single light mix the light source light so as to generate the partial light of the white light and there are many kinds of dispositions of the light source that emits the partial light, whereby there are the many kinds of brightness distributions of the plurality of pieces of partial light.

Besides, as an example in which there are the many kinds of brightness distributions of the plurality of pieces of partial light due to the light source, there is an example, in which the plurality of light sources include light sources that are different from one another in output direction of the light source light, whereby there are the many kinds of the brightness distributions of the plurality of pieces of partial light.

Here, if the display deice includes a brightness measurement portion that measures the brightness of the light source light, in a case where a change occurs in the brightness distribution of the partial light because of at least one of: (1) fault with the light source that emits the light source light, (2) adhering matter on the light source that blocks the light source light, and (3) temperature rise of the light source due to the light emission, it is desirable that the panel control data correction portion selects a correction filter in accordance with a measurement result from the brightness measurement portion.

According to this, even in the display device that is continuously driven, the correspondence between the brightness adjustment data relating to the brightness of the light source and the correction panel control data improves, whereby the quality of the display image on the liquid crystal display device surely improves.

Here, in the control unit, the filter process portion, by means of different brightness distribution filters, may apply a process to the brightness adjustment data that correspond to each of the plurality of light sources for generating the partial light so as to generate the brightness distribution data of the output light from the illumination device; and the correction panel control data for controlling the display image on the display panel may be generated, from the brightness distribution data and the panel control data, by the panel control data correction portion.

According to this, the brightness distribution data of each piece of partial light becomes exact, and the brightness distribution data of the output light becomes exact. Because of this, correspondence between the brightness distribution data of the output light and the correction panel control data improves, whereby the quality of the display image on the liquid crystal display device surely improves.

Here, as the plurality of light sources that generate the partial light, a plurality of multi-color light sources, which include: a red-light emitting light source; a green-light emitting light source; and a blue-light emitting light source, may be disposed, or a plurality of light sources, which include light sources having the same color like a white color, may be disposed.

Besides, even in the display device which includes the filter process portion that by means of different brightness distribution filters, applies a process to the brightness adjustment data which correspond to each of the plurality of light sources for generating such partial light, if the display device includes the brightness measurement portion that measures the brightness of the light source light, the following is desirable.

In other words, in a case where a change occurs in the brightness distribution of the partial light because of at least one of: (1) fault with the light source that emits the light source light, (2) adhering matter on the light source that blocks the light source light, and (3) temperature rise of the light source due to the light emission, it is desirable that the panel control data correction portion selects a correction filter in accordance with a measurement result from the brightness measurement portion.

According to this, like in the above description, even in the display device that is continuously driven, the correspondence between the brightness adjustment data relating to the brightness of the light source and the correction panel control data improves, whereby the quality of the display image on the liquid crystal display device surely improves.

### Advantageous Effects of Invention

According to the present invention, the display image on the display panel is controlled in accordance with the brightness distribution of the output light from the illumination device (in short, correspondence between the brightness distribution of the output light including the plurality of pieces of partial light and the brightness distribution of the display image on the display panel improves). Because of this, the quality of the display image on the liquid crystal display device surely improves.

### BRIEF DESCRIPTION OF DRAWINGS

FIG. 1 is a block diagram showing various members included in an image control portion shown in FIG. 2.

FIG. 2 is a block diagram showing various members included in a liquid crystal display device.

FIG. 3 is a description view showing a relationship among light source control data, backlight, an LED, and brightness adjustment data for the LED.

FIG. 4 (A), (B) and (C) are each a description view showing a brightness distribution filter whose specific numerical examples of filter values are indicated.

FIG. 5 (A) is a description view showing a data standard (data map) of 9×7 matrix type that is a standard of brightness distribution data; and (B) is a description view that indicates positions of a plurality of brightness adjustment data by means of the data map shown in (A).

FIG. 6 (A) is a description view showing a state in which a position of one brightness adjustment datum is set near an upper left position in the data map shown in FIG. 5A; (B) is a description view showing a brightness distribution filter for processing the brightness adjustment data shown in (A); and (C) is a description view showing data after the processing by means of the brightness distribution filter shown in (B).

FIG. 7 (A) is a description view showing a state in which a position of one brightness adjustment datum is set near an upper right position in the data map shown in FIG. 5A; (B) is a description view showing a brightness distribution filter for processing the brightness adjustment data shown in (A); and (C) is a description view showing data after the processing by means of the brightness distribution filter shown in (B).

FIG. 8 (A) is a description view showing a state in which a position of one brightness adjustment datum is set near a lower left position in the data map shown in FIG. 5A; (B) is a description view showing a brightness distribution filter for processing the brightness adjustment data shown in (A); and (C) is a description view showing data after the processing by means of the brightness distribution filter shown in (B).

FIG. 9 (A) is a description view showing a state in which a position of one brightness adjustment datum is set near a lower right position in the data map shown in FIG. 5A; (B) is a description view showing a brightness distribution filter for processing the brightness adjustment data shown in (A); and (C) is a description view showing data after the processing by means of the brightness distribution filter shown in (B).

FIG. 10 is a description view showing brightness distribution data obtained from the data after the processing shown in FIG. 6C, FIG. 7C, FIG. 8C, and FIG. 9C.

FIG. 11 is related to an example 1; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 12 is related to an example 2; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 13 is related to an example 3; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 14 is related to an example 4; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 15 is related to an example 5; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; (D) is a description view showing still another piece of partial light and a brightness distribution filter corresponding to brightness adjustment data for an LED for generating the still another piece of partial light; and (E) is a description view showing that brightness distribution data are generated from the brightness distribution filters shown in (B), (C) and (D).

FIG. 16 is an exploded perspective view of a backlight unit included in a liquid crystal display device.

FIG. 17 is related to an example 6; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 18 (A), (B) are each a description view showing a brightness distribution filter whose specific numerical examples of filter values are indicated.

FIG. 19 is an exploded perspective view of a backlight unit included in a liquid crystal display device.

FIG. 20 is related to an example 7; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 21 is related to an example 8; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; (D) is a description view showing still another piece of partial light and a brightness distribution filter corresponding to brightness adjustment data for an LED for generating the still another piece of partial light; and (E) is a description view showing that brightness distribution data are generated from the brightness distribution filters shown in (B), (C) and (D).

FIG. 22 is related to an example 9; (A) is a plan view showing backlight and LEDs; (B) is a description view showing a piece of partial light and a brightness distribution filter corresponding to brightness adjustment data for an LED for generating the piece of partial light; (C) is a description view showing another piece of partial light and a brightness distribution filter corresponding to brightness adjustment data for an LED for generating the another piece of partial light; and (D) is a description view showing that brightness distribution data are generated from the brightness distribution filters shown in (B) and (C).

FIG. 23 is a description view showing a brightness distribution filter whose specific numerical examples of filter values are indicated.

FIG. 24 is an exploded perspective view of a liquid crystal display device.

### DESCRIPTION OF EMBODIMENTS

### Embodiment 1

An embodiment 1 is described with reference to drawings as follows. Here, for the sake of convenience, there is a case where member numbers and the like are omitted; in such a case, other drawings are referred to. Besides, for the sake of convenience, there is a case where although not a sectional view, hatching is used. Besides, a black dot indicated together with an arrow means a direction perpendicular to the paper surface. Besides, there is a case where a reference number indicating a kind of signal is attached to an arrow indicating a traveling direction of the signal; however, the arrow does not always indicate the traveling of the kind of signal only.

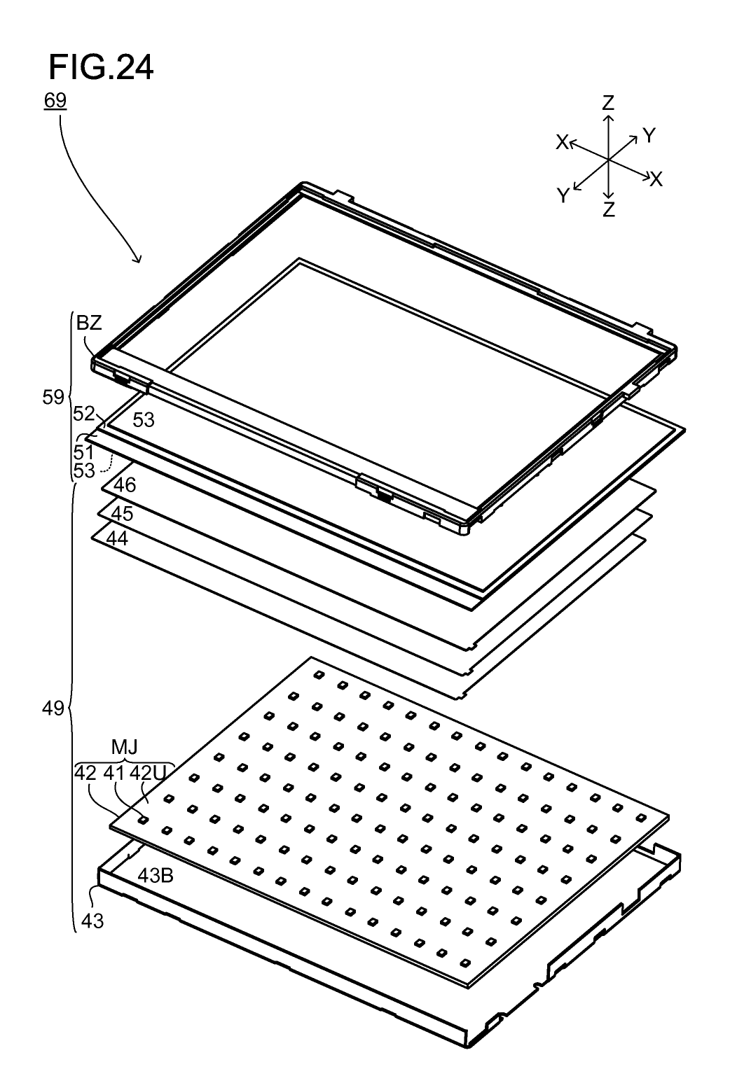

FIG. 24 is an exploded perspective view of a liquid crystal display device 69.

As shown in this figure, the liquid crystal display device 69 includes: a liquid crystal display panel 59; and a backlight unit (illumination device) 49 that supplies light to the liquid crystal display panel 59.

The liquid crystal display panel 59 includes an active matrix board 51 and an opposite board 52 that sandwich not-shown liquid crystal (here, these boards 51, 52 are fitted in a frame-shaped bezel BZ). Besides, on the active matrix board 51, although not shown, a gate signal line and a source signal line are disposed to cross over each other; further, at every intersection of both signal lines, a switching element (e.g., Thin Film Transistor) necessary for adjusting a voltage applied to the liquid crystal is disposed.

Besides, a light polarization film 53 is disposed on a light receiving side of the active matrix board 51 and an output side of the opposite board 52. And, the above-described liquid crystal display panel 59 makes use of a change in light transmittance due to an inclination of liquid crystal molecules to display an image.

Next, the backlight unit 49, which is situated right under the liquid crystal display panel 59 and supplies light (backlight BL) to the liquid crystal display panel 59, is described. The backlight unit 49 includes: an LED module (light emitting module) MJ: a backlight chassis 43; a diffusion plate 44; a prism sheet 45; and a prism sheet 46.

The LED module MJ includes: a mount board 42; and an LED (Light Emitting Diode) 41.

The mount board 42 is a rectangular board, for example, and a plurality of electrodes (not shown) are arranged on a mount surface 42U. And, on these electrodes, LEDs 41 which are light emitting diodes are disposed. The electrodes are disposed along two directions intersecting (meeting at right angles) each other on the mount surface 42U of one mount board 42 (in other words, the electrodes are disposed in a grid shape).

Accordingly, the LEDs 41 are disposed on the electrodes, and when the LEDs 41 emit light, the light (light source light) from the plurality of the LEDs 41 is collected and surface light is generated. Here, in the disposition of the electrodes (and the LEDs 41), of the two intersecting directions, a line which has a larger number of electrodes disposed in parallel is defined as an X direction, while a line which has a smaller number of electrodes is defined as a Y direction; further, a direction intersecting the X direction and the Y direction is defined as a Z direction (here, the X direction corresponds to a long edge of a screen of the liquid crystal display panel 59, while the Y direction corresponds to a short edge of the screen of the liquid crystal display panel 59).

The LED 41 is a light source (light emitting element, point light source), and emits light by means of an electric current supplied via the electrode of the mount board 42. And, there are many kinds of the LEDs 41, and an example is the LED 41 which includes, for example, a red-light emitting red LED chip, a green-light emitting green LED chip, and a blue-light emitting blue LED chip; and mixes the light from all of the LED chips to generate white light.

The backlight chassis 43, as shown in FIG. 24, is, for example, a box-shaped member, and houses the LED module MJ in a bottom surface 43B. Here, the bottom surface 43B of the backlight chassis 43 and the mount board 42 of the LED module MJ are connected to each other via a rivet (not shown), for example.

The diffusion plate 44 is a plate-shaped optical member that overlies the mount surface 42U crammed with the LEDs 41, receives the light emitted from the LED module MJ, and diffuses the light. In other words, the diffusion plate 44 diffuses the surface light formed by the plurality of the LED modules MJ and spreads the light throughout the entire region of the liquid crystal display panel 59.

The prism sheets 45, 46 are each an optical sheet which has, for example, a prism shape on a sheet surface, deflects a light radiation characteristic, and is situated to cover the diffusion plate 44. Because of this, the prism sheets 45, 46 collect the light traveling from the diffusion plate 44 to improve brightness. Here, diffusion directions of the respective light collected by the prism sheet 45 and the prism sheet 46 are in a relationship to intersect each other.

And, the above-described backlight unit 49 transmits the surface light BL (the backlight BL) formed by the LED module MJ through the plurality of the optical members 41 to 46, and supplies the light to the liquid crystal display panel 59. According to this, the liquid crystal display panel 59 of non-light emitting type receives the backlight BL from the backlight unit 49 and improves a display function.

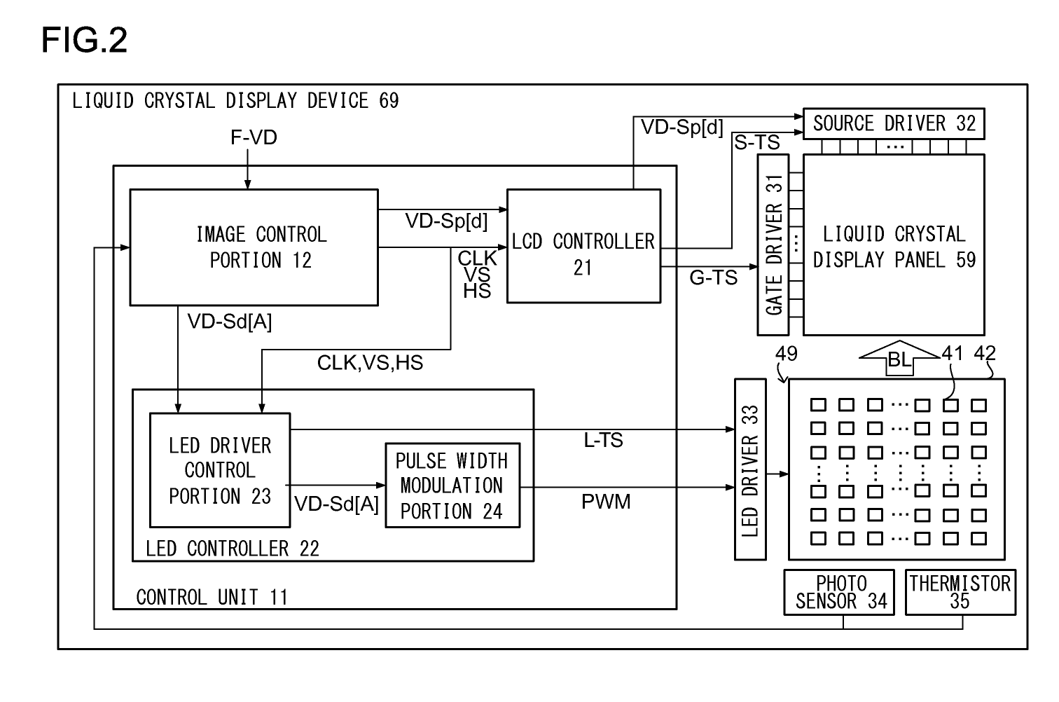

FIG. 2 is a block diagram showing various members related to the liquid crystal display device 69. As shown in this figure, such liquid crystal display device 69 includes a control unit 11, this control unit 11 comprehensively controls the liquid crystal display device 69 (in other words, the liquid crystal display panel 59 and the backlight unit 49).

Describing in detail, the control unit 11 includes: an image control portion 12;

a liquid crystal display panel controller (LCD controller) 21; and an LED controller 22 (here, a gate driver 31, a source driver 32, an LED driver 33, a photo sensor 34, and a thermistor 35 which are included in the liquid crystal display device 69 are also described).

The image control portion 12 receives image data F-VD that is an initial image signal from an external signal source. This image data F-VD is, for example, a television signal, and includes image data and synchronization data that synchronizes with the image data (here, the image data includes brightness data of red, green, and blue, for example).

And, the image control portion 12 generates, from the synchronization data, new synchronization data (clock data CLK, vertical synchronization data VS, horizontal synchronization data HS and the like) that are necessary for image display on the liquid crystal display panel 59. Thereafter, the image control portion 12 transmits the new generated synchronization data to the LCD controller 21 and the LED controller 22.

Besides, the image control portion 12 separates the image data into: separator data VD-Sp (panel control data VD-Sp) suitable for driving of the liquid crystal display panel 59; and separator data VD-Sd (light source control data VD-Sd) suitable for driving of the backlight unit 49 (describing in detail, the LEDs 41).

And, the image control portion 12 applies a predetermined correction to the panel control data VD-Sp to form correction panel control data VD-Sp [d] and transmits them to the LCD controller 21.

Besides, the image control portion 12 applies a predetermined process to the light source control data VD-Sd in accordance with a piece of local light (partial light PL) included in the surface light generated by the LEDs 41 to form brightness adjustment data VD-Sd [A] and transmits them to the LED controller 22. Here, details of the image control portion 12 are described later.

The LCD controller 21, from the clock data CLK, the vertical synchronization data VS, the horizontal synchronization data and the like that are transmitted from the image control portion 12, generates timing data for controlling the gate driver 31 and the source driver 32 (here, timing data corresponding to the gate driver 31 is defined as timing data G-TS, and timing data corresponding to the source driver 32 is defined as timing data S-TS).

And, the LCD controller 21 transmits the timing data G-TS to the gate driver 31. On the other hand, the LCD controller 21 transmits the timing data S-TS and the correction panel control data VD-Sp [d] to the source driver 32.

Then, the source driver 32 and the gate driver 31 use both of the timing data G-TS, S-TS and the correction panel control data VD-Sp [d] to control the image on the liquid crystal display panel 59 (describing in detail, controls the light transmittance of the pixel of the liquid crystal display panel 59).

The LED controller 22 includes an LED driver control portion 23 and a pulse width modulation portion 24.

The LED driver control portion 23 transmits the brightness adjustment data

VD-Sd [A] from the image control portion 12 to the pulse width modulation portion 24. Besides, the LED driver control portion 23, from the synchronization data (the clock data CLK, the vertical synchronization data VS, the horizontal synchronization data HS and the like), generates turn-on timing data L-TS for the LED 41 and transmits them to the LED driver 33.

The pulse width modulation portion 24, based on the received brightness adjustment data VD-Sd [A], adjusts a light emission time of the LED 41 by means of a pulse width modulation (PWM) system (here, a signal value used for such pulse width modulation is called a PWM signal). Describing in detail, the pulse width modulation portion 24 transmits the PWM signal suitable for light emission control of the LED 41 to the LED driver 33.

Then, the LED driver 33, based on signals (the PWM signal, the timing data L-TS) from the LED controller 22, performs turn-on control of the LED 41 (here, the control unit 11 for controlling the light emission of the LED 41 is capable of comprehensively controlling all of the LEDs 41 at the same time; however, this is not limiting, and has a local dimming function that is capable of controlling the light emission of each of the LEDs 41).

Here, the photo sensor (brightness measurement portion) 34 measures the brightness of the LED 41 and transmits the measurement result to the image control portion 12. Describing in detail, as a material for determination by the image control portion 12, for example, as a material to determine a turn-on state of the LED 41, or a material to determine whether adhering matter blocking the output light from the LED 41 adheres to the LED 41 or not, the photo sensor 34 measures the brightness (describing in detail, the partial light PL) of the LED 41 and transmits the measurement result to the image control portion 12. Here, the number of the photo sensors 34 may be single or plural (e.g., a plurality of the photo sensors 34 may be disposed in accordance with the number of pieces of the partial light).

Besides, considering a case where the LED 41 is heated because of the light emission, the thermistor (temperature measurement portion) 35 measures a temperature of the LED 41 and transmits the measurement result to the image control portion 12. Describing in detail, as a material for determination by the image control portion 12, for example, as a material to determine a drop in light emission efficiency of the LED 41 (in short, to detect a junction temperature of the LED 41), the thermistor 35 measures the temperature of the LED 41 and transmits the measurement result to the image control portion 12. Here, the number of the thermistors 35 may be single or plural (e.g., a plurality of the thermistors 35 may be disposed in accordance with the number of pieces of the partial light).

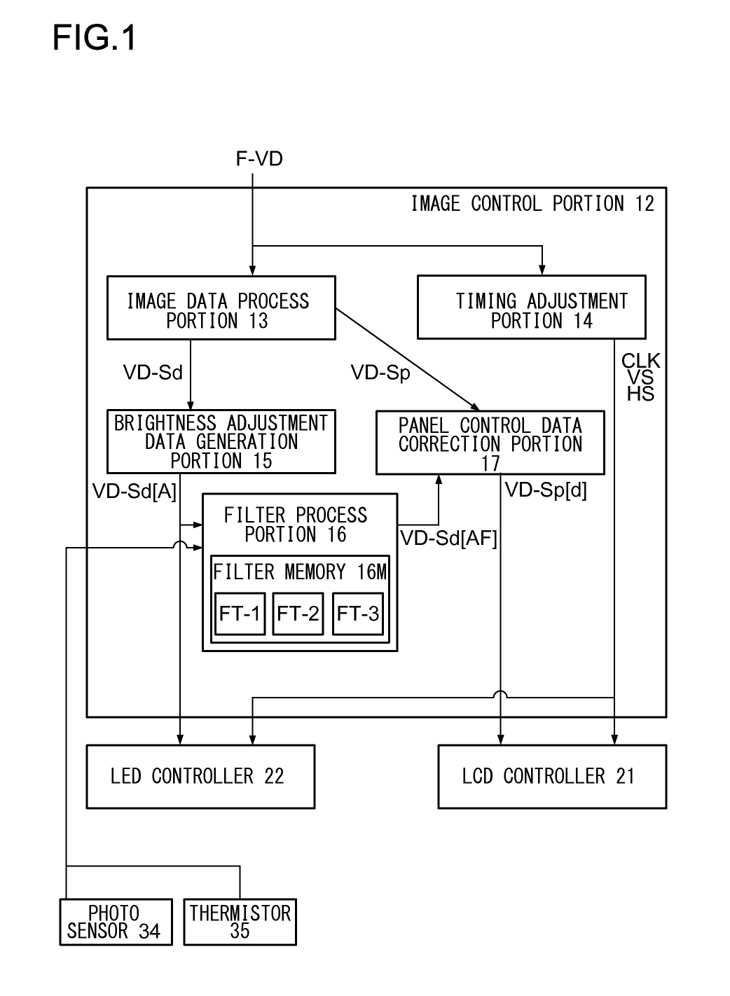

Here, the image control portion 12 is described in detail using a block diagram in FIG. 1. The image control portion 12 includes: an image data process portion 13; a timing adjustment portion 14; a brightness adjustment data generation portion 15; a filter process portion 16; and a panel control data correction portion 17.

The image data process portion 13, as described above, from the image data of the received initial image data F-DV, generates the panel control data VD-Sp and the light source control data VD-Sd. And, the image data process portion 13 transmits the panel control data VD-Sp to the panel control data correction portion 17, and transmits the light source control data VD-Sd to the brightness adjustment data generation portion 15.

The timing adjustment portion 14, as described above, from the received initial image data F-DV, generates the new synchronization data (the clock data CLK, the vertical synchronization data VS, the horizontal synchronization data HS and the like) necessary for the image display on the liquid crystal display panel 59, and transmits those synchronization data to the LCD controller 21 and the LED controller 22.

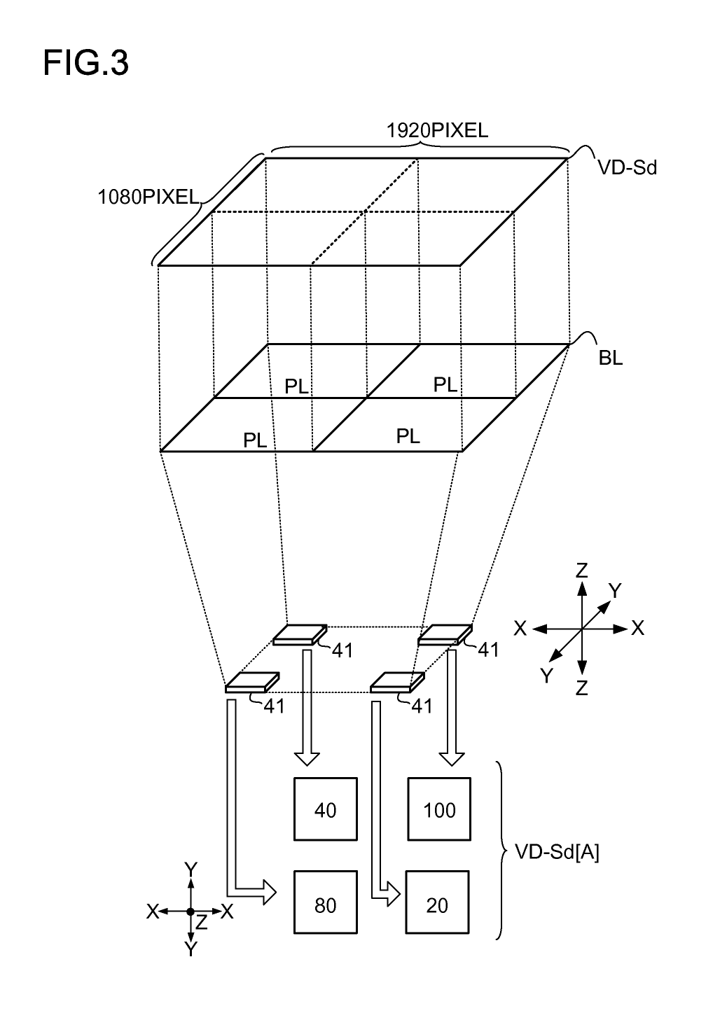

The brightness adjustment data generation portion 15, based on the received light source control data VD-Sd, generates the brightness adjustment data VD-Sd [A] for controlling the LEDs 41. For example, as shown in FIG. 3, it is assumed that the light source control data VD-Sd is data for the total number of the pixels (e.g., 1920×1080) of the liquid crystal display panel 59; and thanks to a 2×2 disposition of the LEDs 41, the surface light BL (the backlight BL) from the backlight unit 49 is formed of an aggregate of a total of four pieces of local light (the partial light PL).

In this case, the brightness adjustment data generation portion 15 divides the light source control data VD-Sd in conformity with a data standard (data map) of 1920×1080 making them correspond to the partial light. And, desired brightness data is obtained from all brightness data of the divided light source control data VD-Sd.

For example, to control the LED 41 based on the maximum brightness of the light source control data VD-Sd, the brightness adjustment data generation portion 15 detects the maximum brightness data from all the brightness data for each color of the light source control data VD-Sd that is divided in accordance with the partial light PL (in other words, the maximum brightness data corresponding to each color of red, green, and blue is detected for each piece of the partial light PL).

And, the brightness adjustment data generation portion 15 transmits the maximum brightness data to the LED controller 22 as the brightness adjustment data VD-Sd [A] for controlling the LEDs 41 (here, the brightness adjustment data VD-Sd [A] is not always the maximum brightness data of all the brightness data for each color, and, for example, may be a different kind of data such as average brightness data or the like).

Here, the description is continued assuming, for easy understanding, that as for a data value of the brightness adjustment data VD-Sd [A] corresponding to the LED 41 shown in FIG. 3, for example,

the data value of the brightness adjustment data VD-Sd [A] corresponding to the LED 41 for generating the partial light PL at upper left of the four pieces of the 2×2 partial light PL is “40”;

the data value of the brightness adjustment data VD-Sd [A] corresponding to the LED 41 for generating the partial light PL at upper right of the four pieces of the 2×2 partial light PL is “100”;

the data value of the brightness adjustment data VD-Sd [A] corresponding to the LED 41 for generating the partial light PL at lower left of the four pieces of the 2×2 partial light PL is “80”; and

the data value of the brightness adjustment data VD-Sd [A] corresponding to the LED 41 for generating the partial light PL at lower right of the four pieces of the 2×2 partial light PL is “20”.

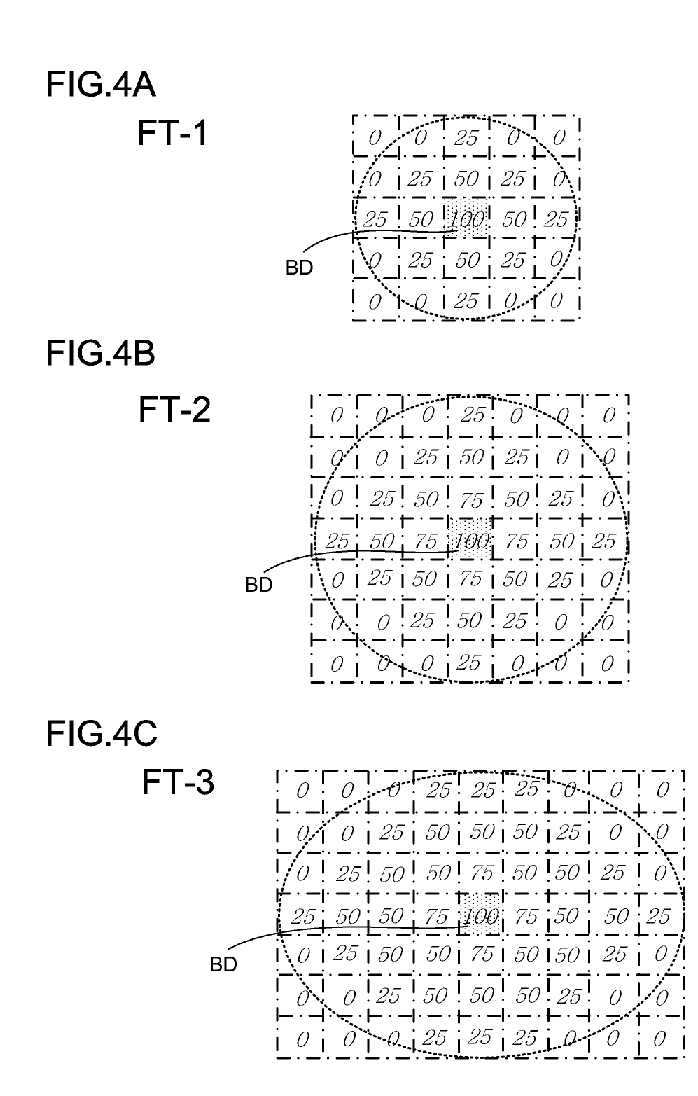

The brightness adjustment data generation portion 15 transmits the brightness adjustment data VD-Sd [A] to the LED controller 22 and the filter process portion 16 as well. This filter process portion 16 incorporates a filter memory 16M that stores, for example, a plurality of brightness distribution filters FT (FT-1, FT-2, FT-3) shown in FIG. 4A, FIG. 4B, and FIG. 4C, and when necessary, processes the brightness adjustment data VD-Sd [A] by means of an optimum brightness distribution filter FT (here, the storage system for the brightness distribution filter FT is not limited to the filter memory 16M).

Here, in a case where there is a difference in brightness distribution of the partial light PL due to the LED 41, the brightness distribution filter FT is a filter for obtaining brightness distribution data of the backlight BL considering the difference (here, in FIG. 4A to FIG. 4C, and in other figures described later, a dotted line indicated in the brightness distribution filter FT schematically shows an outer shape of an obtained brightness distribution). Because of this, the brightness adjustment data VD-Sd [A] after the processing is defined as brightness distribution data VD-Sd [AF] (here, details are described later).

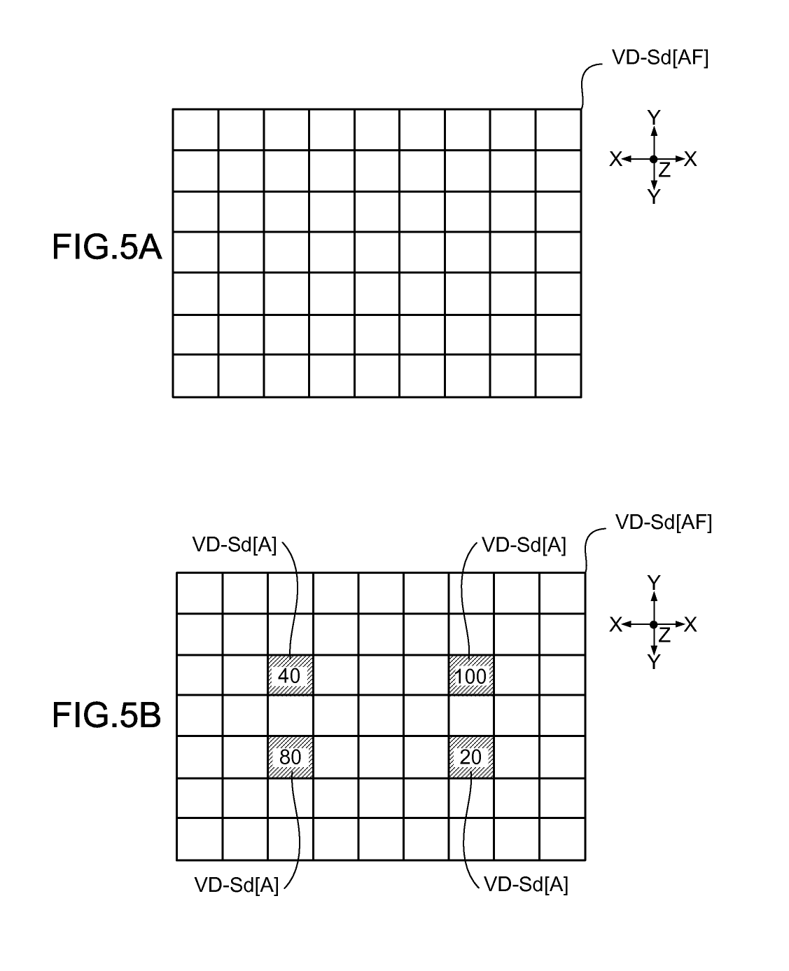

The brightness distribution data VD-Sd [AF] is obtained as described below, for example. First, the filter process portion 16 sets a standard of the brightness distribution data VD-Sd [AF]. It is assumed that as for this standard, a data standard of 9×7 matrix type shown in FIG. 5A, for example, is set considering the surface-shaped backlight BL.

Next, the filter process portion 16 sets a plurality of positions of the brightness adjustment data VD-Sd [A] (e.g., “40,” “100,” “80,” and “20”) in accordance with the data standard of the brightness distribution data VD-Sd [AF]. The positions reflect positions of the LEDs 41 on the backlight chassis 43. Because of this, as shown in FIG. 3, when the LEDs 41 are disposed into the 2×2 matrix, the positions of the brightness adjustment data VD-Sd [A] are disposed into a matrix shape in the data standard of 9×7 as shown in FIG. 5B (slantingly hatched portions are the positions of the brightness adjustment data VD-Sd [A]).

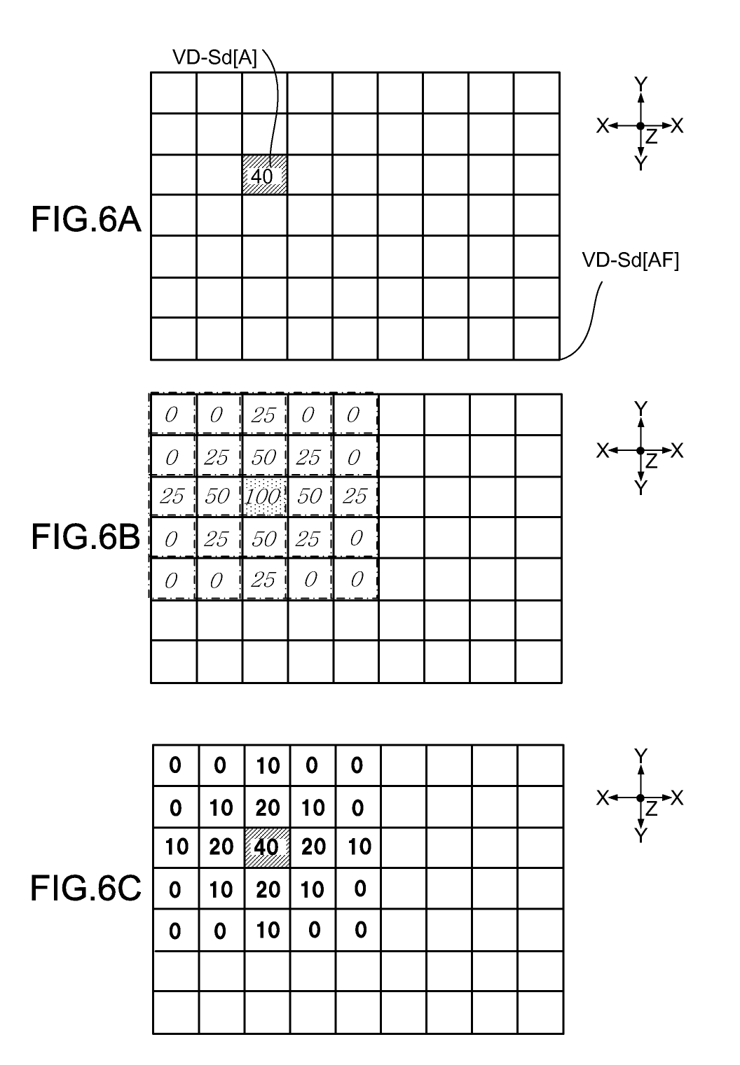

And, the filter process portion 16 corrects each of the brightness adjustment data VD-Sd [A] by means of a suitable brightness distribution filter FT. For example, if the filter process portion 16 determines that the brightness distribution filter FT-1 is suitable for the data value “40” of the brightness adjustment data VD-Sd [A] shown in FIG. 6A, the filter process portion 16, as shown in FIG. 6B, matches a reference position BD (the value “100” in a dot shading portion of the filter) of the brightness distribution filter FT-1 with the brightness adjustment data VD-Sd [A].

And, the filter process portion 16 multiplies each filter value of the brightness distribution filter FT-1 by the data value “40” of the brightness adjustment data VD-Sd [A], further, divides the multiplied values by an adjustment value of “100” to make the multiplied values small. The division results are shown in FIG. 6C.

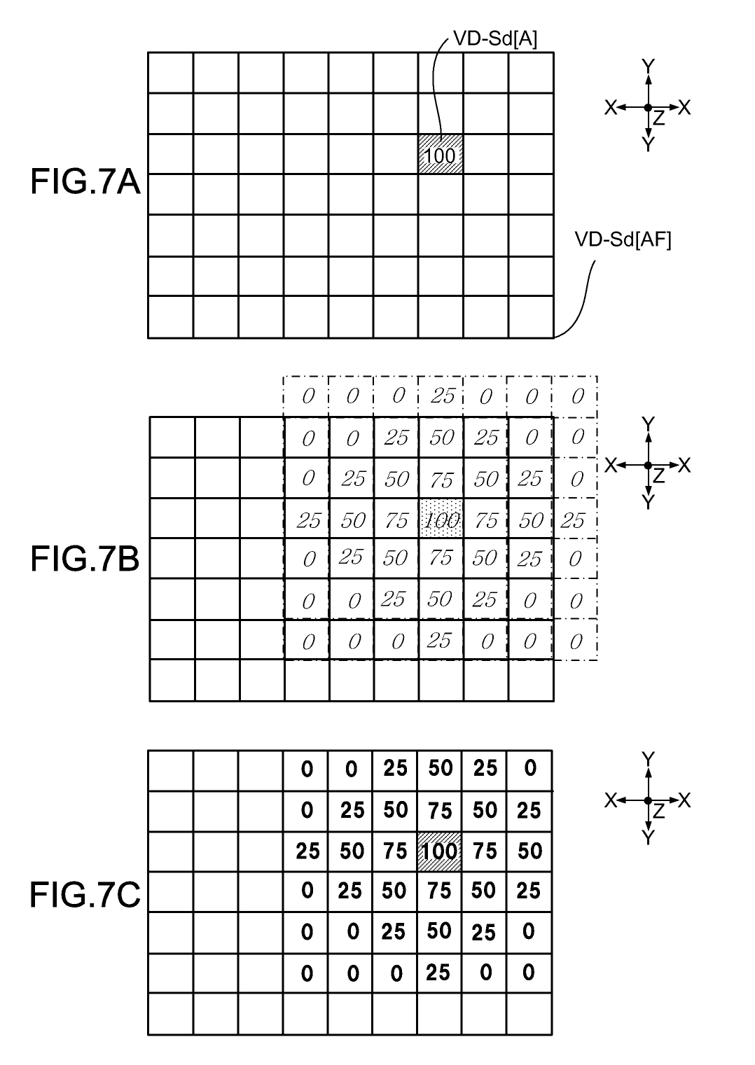

Next, the filter process portion 16 determines the brightness distribution filter FT suitable for the data value “100” of the brightness adjustment data VD-Sd [A] shown in FIG. 7A. And, if the filter process portion 16 determines that the brightness distribution filter FT-2 is suitable for the data value “100” of the brightness adjustment data VD-Sd [A], the filter process portion 16, as shown in FIG. 7B, matches a reference position BD (the value “100” in a dot shading portion of the filter) of the brightness distribution filter FT-2 with the brightness adjustment data VD-Sd [A].

And, the filter process portion 16 multiplies each filter value of the brightness distribution filter FT-2 by the data value “100” of the brightness adjustment data VD-Sd [A], further, divides the multiplied values by the adjustment value of “100” (here, filter values falling outside the matrix-shaped data standard are not calculated). The division results are shown in FIG. 7C.

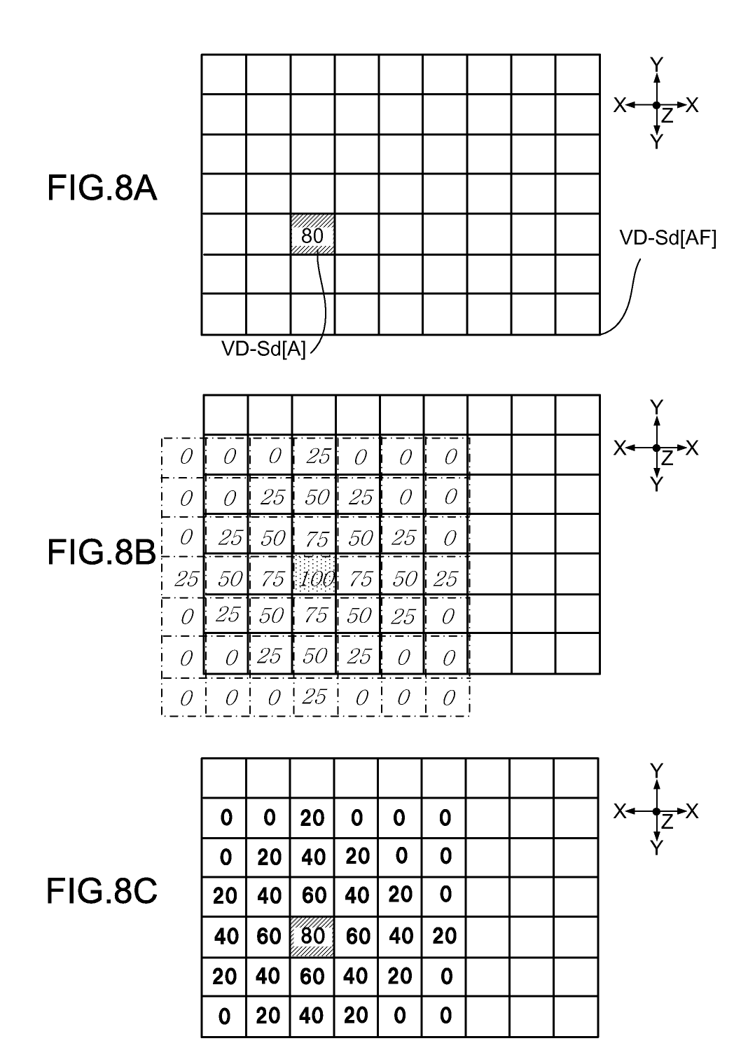

Next, the filter process portion 16 determines the brightness distribution filter FT suitable for the data value “80” of the brightness adjustment data VD-Sd [A] shown in FIG. 8A. And, if the filter process portion 16 determines that the brightness distribution filter FT-2 is suitable for the data value “80” of the brightness adjustment data VD-Sd [A], the filter process portion 16, as shown in FIG. 8B, matches the reference position BD of the brightness distribution filter FT-2 with the brightness adjustment data VD-Sd [A].

And, the filter process portion 16 multiplies each filter value of the brightness distribution filter FT-2 by the data value “80” of the brightness adjustment data VD-Sd [A], further, divides the multiplied values by the adjustment value of “100” (here, like in the above description, the filter values falling outside the matrix-shaped data standard are not calculated). The division results are shown in FIG. 8C.

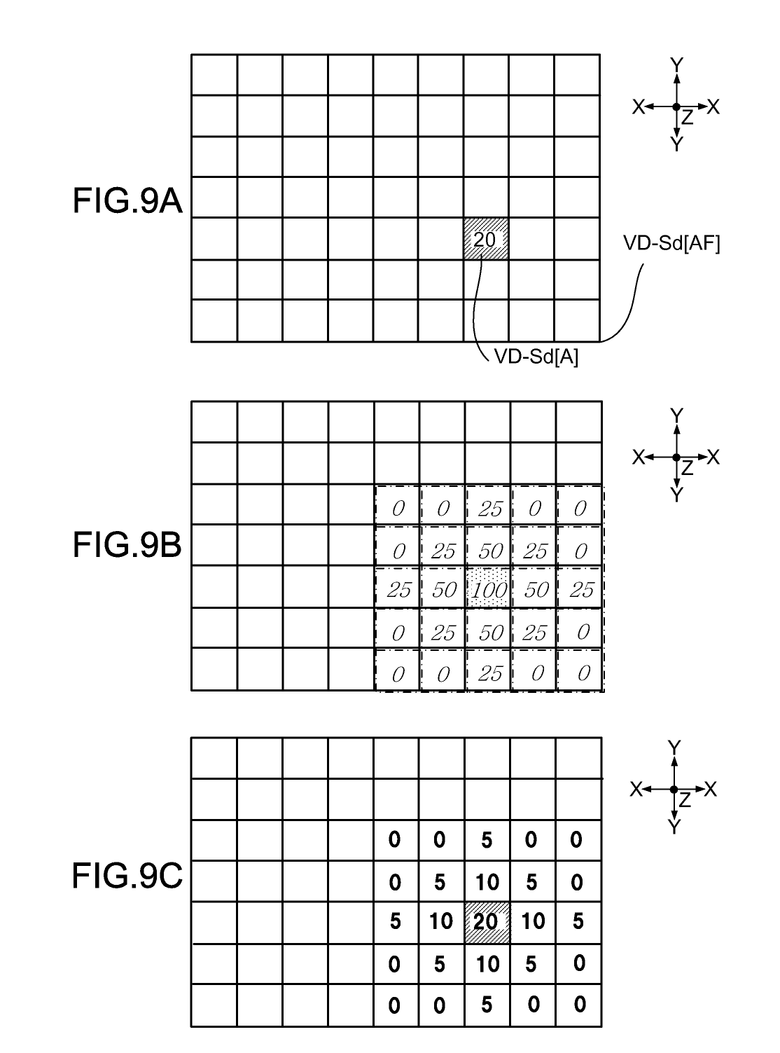

Next, the filter process portion 16 determines the brightness distribution filter FT suitable for the data value “20” of the brightness adjustment data VD-Sd [A] shown in FIG. 9A. And, if the filter process portion 16 determines that the brightness distribution filter FT-1 is suitable for the data value “20” of the brightness adjustment data VD-Sd [A], the filter process portion 16, as shown in FIG. 9B, matches the reference position BD of the brightness distribution filter FT-1 with the brightness adjustment data VD-Sd [A].

And, the filter process portion 16 multiplies each filter value of the brightness distribution filter FT-1 by the data value “20” of the brightness adjustment data VD-Sd [A], further, divides the multiplied values by the adjustment value of “100”. The division results are shown in FIG. 9C.

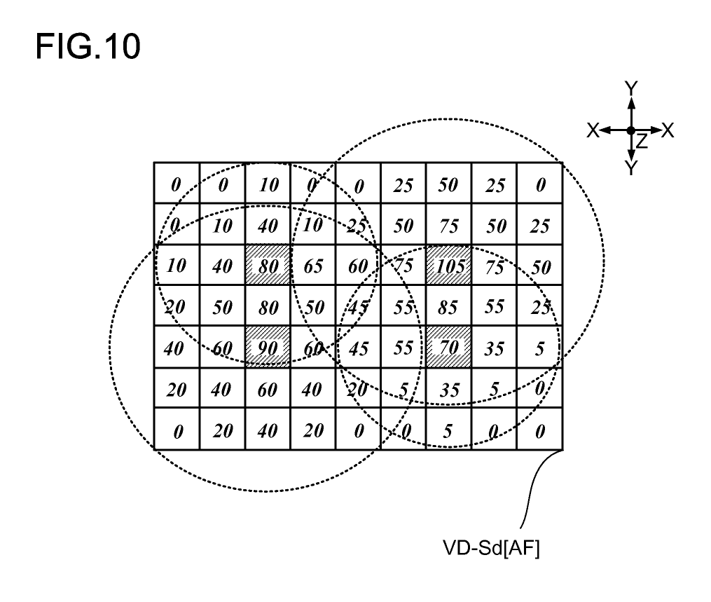

And, the filter process portion 16 adds the divided values shown in FIG. 6C, FIG. 7C, FIG. 8C, and FIG. 9C for every matrix of the data standard of the brightness distribution data VD-Sd [AF], that is, for every square as shown in FIG. 10 (here, in FIG. 6C, FIG. 7C, FIG. 8C, and FIG. 9C, it is assumed that squares in which a data value is not specified have a data value of “0”).

According to this, in the filter process portion 16, the maximum brightness data (in other words, the brightness adjustment data VD-Sd [A]), which is a constituent portion of the brightness distribution of each piece of the partial light PL, is processed by means of suitable one of the plurality of kinds of the brightness distribution filters FT, whereby the brightness distribution data is obtained, further, the brightness distribution data overlap with each other, whereby brightness distribution data reflecting interference and the like between the partial light PL is generated.

And, the filter process portion 16 transmits the brightness distribution data, that is, the brightness distribution data VD-Sd [AF], which are the processed brightness adjustment data VD-Sd [A], to the panel control data correction portion 17. In other words, to reflect the brightness distribution data VD-Sd [AF] into the panel control data VD-Sp (in other words, to apply a correction to the panel control data VD-Sp), the filter process portion 16 transmits the brightness distribution data VD-Sd [AF] shown in FIG. 10 to the panel control data correction portion 17.

The panel control data correction portion 17 corrects the panel control data VD-Sp received from the image data process portion 13 by means of the brightness distribution data VD-Sd [AF] received from the filter process portion 16. For example, the filter process portion 16 applies a linear interpolation process to the brightness distribution data VD-Sd [AF] so as to form data of 1920×1080 data like the panel control data VD-Sp, and calculates the panel control data VD-Sp based on the data after the process.

The calculated data are data which reflects the brightness distribution data VD-Sd [AF] into the light source control data VD-Sd, that is, the correction panel control data VD-Sp [d].

In other words, the panel control data correction portion 17, from the data (the brightness distribution data VD-Sd [AF]) after the process which uses the brightness distribution filter FT that corresponds to the brightness of each piece of the partial light PL included in the backlight BL, generates the correction panel control data VD-Sp [d] for controlling the light transmittance of the pixel of the liquid crystal display panel 59 (here, the correction panel control data VD-Sp [d] are generated for each color). And, the display image on the liquid crystal display panel 59 is controlled in accordance with the correction panel control data VD-Sp [d].

Summing up, the image control portion 12 of the control unit 11 includes: the image data process portion 13; the brightness adjustment data generation portion 15; the filter process portion 16; and the panel control data correction portion 17.

The image data process portion 13 obtains the image data; and from the image data, generates the light source control data VD-Sd and the panel control data VD-Sp.

The brightness adjustment data generation portion 15 processes the light source control data VD-Sd in accordance with each piece of the partial light PL included in the backlight BL, thereby generating the brightness adjustment data VD-Sd [A] for controlling the brightness of the LED 41.

The filter process portion processes each of the brightness adjustment data VD-Sd [A] that corresponds to the pieces of partial light PL by means of one of the plurality of the brightness distribution filters FT so as to generate the brightness distribution data VD-Sd [AF], there are many kinds of the brightness distributions of the plurality of pieces of the partial light PL due to the LED 41 (however, to improve the process accuracy, one of the brightness adjustment data VD-Sd [A] might be processed by means of a plurality of the brightness distribution filters FT).

The panel control data correction portion 17, from the brightness distribution data VD-Sd [AF] and the panel control data VD-Sp, generates the correction panel control data VD-Sp [d] for controlling the display image on the liquid crystal display panel 59.

In the above-described image control portion 12, the filter process portion 16, in accordance with the partial light PL, generates the brightness distribution data VD-Sd [AF] by means of the most suitable brightness distribution filter FT of the plurality of the brightness distribution filters FT. Because of this, the brightness distribution data VD-Sd [AF] becomes exact data that reflects interference and the like of each piece of the partial light PL compared with the brightness distribution data generated by one kind of the brightness distribution filter, for example.

Accordingly, correspondence between: the correction panel control data VD-Sp [d] corrected by means of the brightness distribution data VD-Sd [AF]; and the brightness adjustment data VD-Sd [A] becomes highly accurate compared with correspondence between the panel control data VD-Sp and the brightness adjustment data VD-Sd [A]; as a result of this, the quality of the display image on the liquid crystal display device 69 improves (in short, correspondence between the brightness distribution of the backlight BL including the plurality of pieces of the partial light PL and the brightness distribution of the display image on the liquid crystal display panel 59 improves, whereby the quality of the display image on the liquid crystal display device 69 improves).

In addition, even if the LEDs 41 for generating a difference in the partial light

PL have a difference in kind (e.g, a difference in manufacturers, a difference in prices), the quality of the display image on the liquid crystal display device 69 improves, accordingly, the degree of freedom of selecting the LED 41 increases (e.g., for cost reduction, in a plurality of groups of the LEDs 41, a percentage of low-cost LEDs 41 may be raised).

In the meantime, for example, the filter process portion 16 does not change the brightness distribution filer FT in accordance with the panel control data VD-Sp which correspond to a region (display region) of the liquid crystal display panel 59 where the partial light PL enters, but changes the brightness distribution filer FT in accordance with a difference between the brightness distributions of the partial light PL due to the LED 41.

And, as cases where the difference in the brightness distributions of the partial light PL due to the LED 41 occurs, there are examples (EX) 1 to 5 as follows.

### Example 1

For example, in the example 1, there are many kinds of the LEDs 41 which generate the partial light PL by means of the backlight BL (the surface light BL) that is an aggregate of 8×4 pieces of the partial light PL. And, a difference in the kinds depends on whether the LED 41 is a power LED 41H capable of emitting high-brightness light or not (in short, it depends on whether the LED 41 is the power LED 41H that emits relatively high-brightness light or a standard LED 41S that emits light having a standard brightness lower than the high brightness).

The power LED (power light emitting element) 41H is the LED 41 that is capable of securing an illumination of tens of lumens to 100 lumens or more by means of a few watts of relatively high electric power. On the other hand, the standard LED (standard light emitting element) 41S is the LED 41 that is capable of securing an illumination of about a few lumens by means hundreds of milliwatts of electric power (in short, the inherent brightness distribution of the power LED 41 and the inherent brightness distribution of the standard LED 41 are different from each other).

And, because of the difference between the power LED 41H and the standard LED 41S, a brightness distribution of partial light PLh generated by the power LED 41H and a brightness distribution of partial light PLs generated by the standard LED 41S are different from each other, accordingly, the difference is considered.

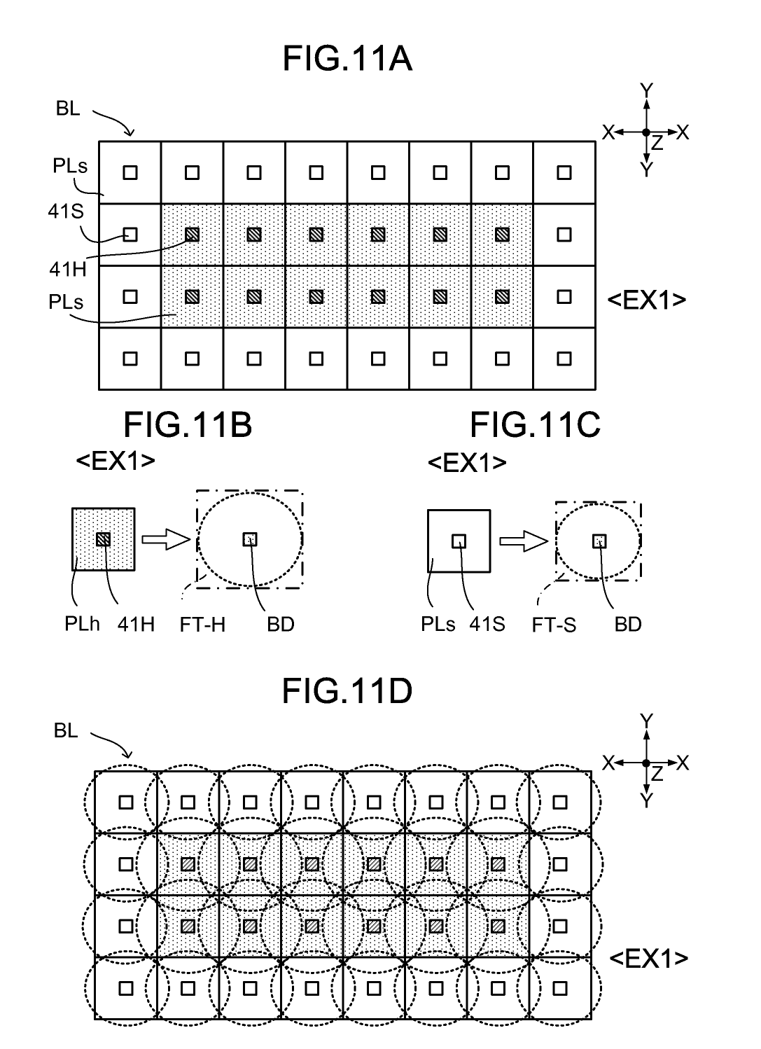

In other words, a brightness distribution filter FT-H corresponding to the brightness adjustment data VD-Sd [A] for the power LED 41H shown in FIG. 11B is different from a brightness distribution filter FT-S corresponding to the brightness adjustment data VD-Sd [A] for the standard LED 41S shown in FIG. 11C.

And, as shown in FIG. 11D, the brightness distribution filter FT-H and the brightness distribution filter FT-S different from each other are used to generate the brightness distribution data VD-Sd [AF] of the backlight BL. In accordance with the difference between the pieces of partial light PL (PLh, PLs) due to the inherent brightness distributions of the LEDs 41, that is, the power LED 41H and the standard LED 41S, the brightness distribution data VD-Sd [AF] is generated by means of the plurality of the brightness distribution filters FT (FT-H, FT-S).

Because of this, the brightness distribution data VD-Sd [AF] becomes exact data that reflects interference and the like of each piece of the partial light PL compared with the brightness distribution data generated by one kind of the brightness distribution filter, for example. Further, the correspondence between the correction panel control data VD-Sp [d], which are the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

### Example 2

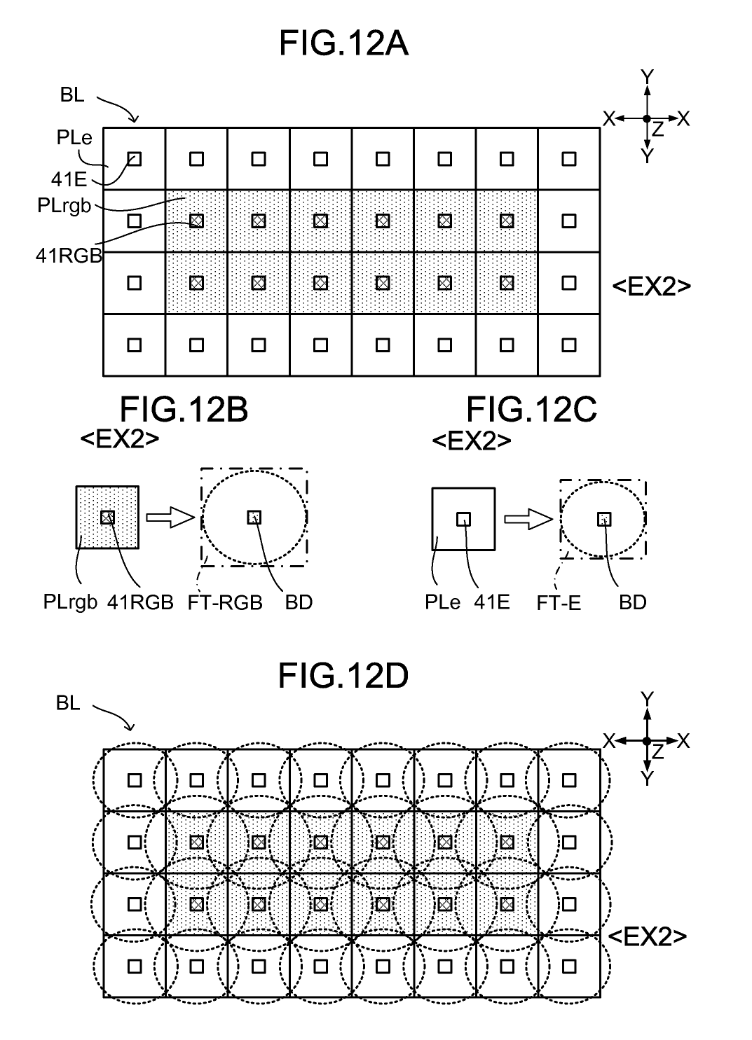

In the example 2, a difference in brightness distribution of the partial light PL due to the LED 41 is a difference in white light generation by the LED 41. This difference depends on whether the LED 41 is an LED 41RGB which includes a multi-color LED chip (light emitting chip) formed of a red-light emitting LED chip, a green-light emitting LED chip, and a blue-light emitting LED chip; and mixes the light from these chips to generate the white light or not, or whether the LED 41 is an LED 41E which includes a blue-light emitting LED chip and a fluorescent body that receives the light from the blue-light emitting LED chip to emit yellow fluorescent light; and mixes the light from the blue-light emitting LED chip and the yellow fluorescent light to generate the white light (see FIG. 12A).

Because of such difference (in other words, the difference between the inherent brightness distribution of the LED 41RGB and the inherent brightness distribution of the LED 41E), a brightness distribution of partial light PLrgb generated by the LED 41RGB and a brightness distribution of partial light PLe generated by the LED 41E are different from each other, accordingly, the difference is considered.

In other words, a brightness distribution filter FT-RGB corresponding to the brightness adjustment data VD-Sd [A] for the LED 41RGB shown in FIG. 12B is different from a brightness distribution filter FT-E corresponding to the brightness adjustment data VD-Sd [A] for the LED 41E shown in FIG. 12C.

And, as shown in FIG. 12D, the brightness distribution filter FT-RGB and the brightness distribution filter FT-E different from each other are used to generate the brightness distribution data VD-Sd [AF] of the backlight BL. In accordance with the difference between the pieces of partial light PL (PLrgb, PLe) due to mechanisms (in short, the inherent brightness distribution of the LED 41RGB and the inherent brightness distribution of the LED 41E) of the white light generation by the LED 41RGB and the LED 41E, the brightness distribution data VD-Sd [AF] is generated by means of the plurality of the brightness distribution filters FT (FT-RGB, FT-E).

Because of this, the brightness distribution data VD-Sd [AF] in the example 2 becomes exact data that reflects interference and the like of each piece of the partial light PL like in the example 1. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference between the power LED 41H and the standard LED 41S in the example 1 and the difference between the LED RGB of three-color mixed type and the LED 41E of fluorescent emission type in the example 2 are combined with each other. However, even in any combination, if the brightness distribution filter FT corresponding to the difference between the brightness distributions of the partial light PL is used, the accuracy of the brightness distribution data VD-Sd [AF] improves.

### Example 3

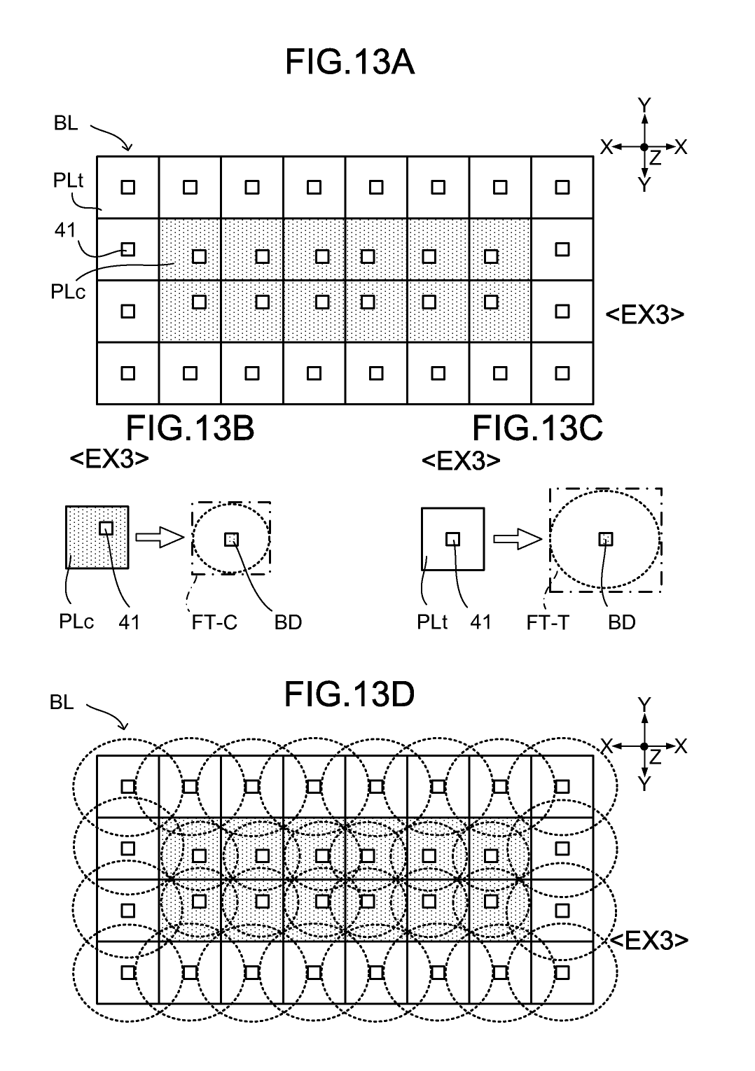

In the example 3, a difference in brightness distribution of the partial light PL due to the LED 41 is a difference in disposition interval (disposition pitch) of the LEDs 41. For example, as shown in FIG. 13A, a disposition interval of the LEDs 41 for generating partial light PLc situated near a center of the backlight BL is different from a disposition interval of the LEDs 41 for generating partial light PLt situated on a circumference of the backlight BL (in short, densities of the LEDs 41 are different from each other).

Because of such difference, a brightness distribution of the partial light PLc situated near the center of the backlight BL and a brightness distribution of the partial light PLt situated on the circumference of the backlight BL are different from each other, accordingly, the difference is considered.

In other words, a brightness distribution filter FT-C corresponding to the brightness adjustment data VD-Sd [A] for the LED 41 for generating the partial light PLc shown in FIG. 13B is different from a brightness distribution filter FT-T corresponding to the brightness adjustment data VD-Sd [A] for the LED 41 for generating the partial light PLt shown in FIG. 13C.

And, as shown in FIG. 13D, the brightness distribution filter FT-C and the brightness distribution filter FT-T different from each other are used to generate the brightness distribution data VD-Sd [AF] of the backlight BL. In accordance with the difference between the pieces of partial light PL (PLc, PLt) due to the disposition of the LEDs 41, the brightness distribution data VD-Sd [AF] is generated by means of the plurality of the brightness distribution filters FT (FT-C, FT-T).

Because of this, the brightness distribution data VD-Sd [AF] in the example 3 becomes exact data that reflects interference and the like of each piece of the partial light PL like in the examples 1 and 2. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the example 1 and the example 2 and the difference between the disposition pitches of the LEDs 41 in the example 3 are combined with each other. However, even in any combination, if the brightness distribution filter FT corresponding to the difference between the brightness distributions of the partial light PL is used, the accuracy of the brightness distribution data VD-Sd [AF] improves.

### Example 4

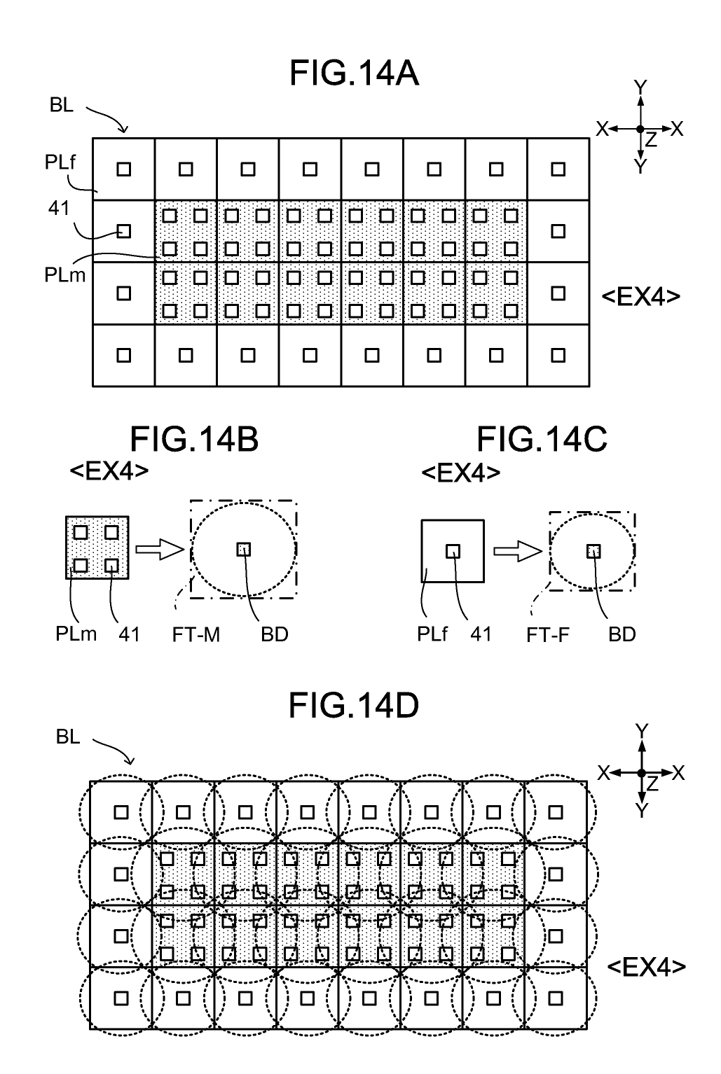

In the example 4, a difference in brightness distribution of the partial light PL due to the LED 41 is a difference in number of the LEDs 41 that generate each piece of the partial light PL. For example, as shown in FIG. 14A, the number of the LEDs 41 for generating partial light PLm situated near a center of the backlight BL is four, while the number of the LEDs 41 for generating partial light PLf situated on a circumference of the backlight BL is one (in short, densities of the LEDs 41 are different from each other).

Because of such difference, a brightness distribution of the partial light PLm situated near the center of the backlight BL and a brightness distribution of the partial light PLf situated on the circumference of the backlight BL are different from each other, accordingly, the difference is considered.

In other words, a brightness distribution filter FT-M corresponding to the brightness adjustment data VD-Sd [A] for the LED 41 for generating the partial light PLm shown in FIG. 14B is different from a brightness distribution filter FT-F corresponding to the brightness adjustment data VD-Sd [A] for the LED 41 for generating the partial light PLf shown in FIG. 14C.

And, as shown in FIG. 14D, the brightness distribution filter FT-M and the brightness distribution filter FT-F different from each other are used to generate the brightness distribution data VD-Sd [AF] of the backlight BL. In accordance with the difference between the pieces of the partial light PL (PLm, PLf) due to the number of the LEDs 41 for generating each piece of the partial light PL, the brightness distribution data VD-Sd [AF] is generated by means of the plurality of the brightness distribution filters FT (FT-M, FT-F).

Because of this, the brightness distribution data VD-Sd [AF] in the example 4 becomes exact data that reflects interference and the like of each piece of the partial light PL like in the examples 1 to 3. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the examples 1 to 3 and the difference between the numbers of the LEDs 41 for generating each piece of the partial light in the example 4 are combined with each other. However, even in any combination, if the brightness distribution filter FT corresponding to the difference between the brightness distributions of the partial light PL is used, the accuracy of the brightness distribution data VD-Sd [AF] improves.

### Example 5

In the example 5, a difference in brightness distribution of the partial light PL due to the LED 41 is a difference in disposition of the LEDs 41 for generating each piece of the partial light PL.

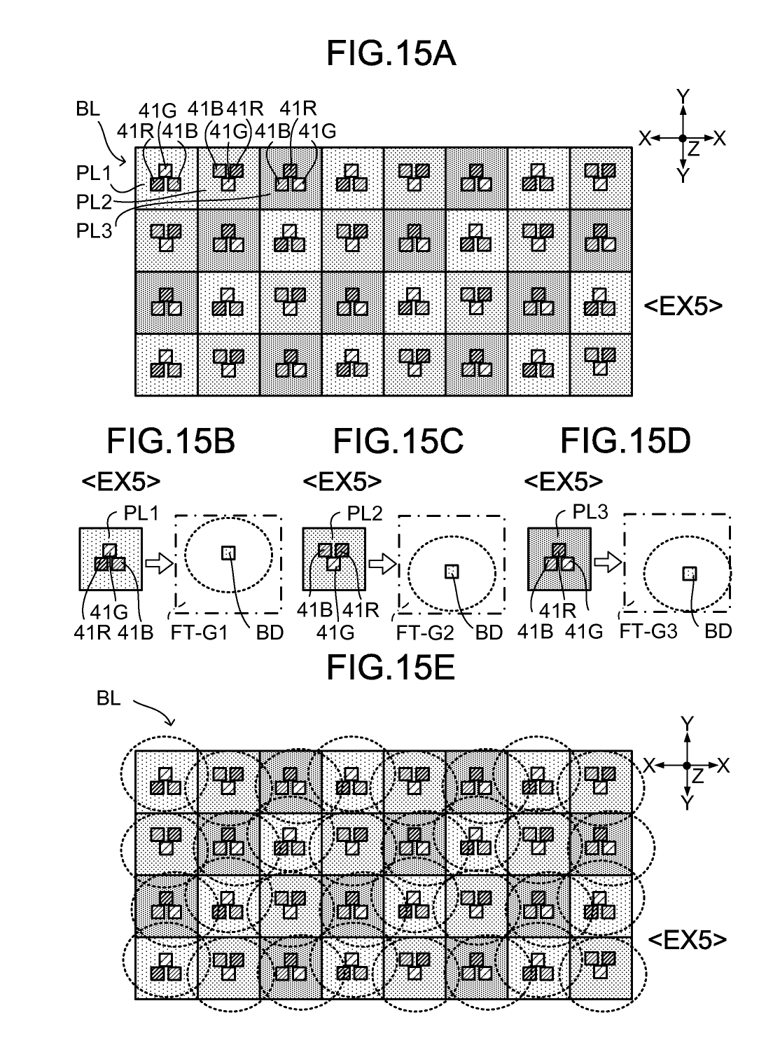

In the examples 1 to 4, one LED 41 generates the partial light PL of the white light. However, by mixing the light from, for example, red-light emitting LEDs 41R, green-light emitting LEDs 41G, and blue-light emitting LEDs 41B which are densely disposed (in other words, densely disposed to be regardable as one point light source), the partial light PL of the white light is generated. Here, such LEDs 41R, LEDs 41G, and LEDs 41B which are densely disposed and the backlight BL are shown in FIG. 15A.

As shown in FIG. 15A, the partial light PL (PL1 to PL3) is generated by the light from the three LEDs (the LED 41R, the LED 41G, and the LED 41B). However, there are many kinds of dispositions of the three LEDs (the LED 41R, the LED 41G, and the LED 41B).

Specifically, there are three kinds of dispositions: a disposition in which the LED 41G, the LED 41B, and the LED 41R are densely arranged clockwise into a triangular shape (Δ shape); a disposition in which the LED 41R, the LED 41G, and the LED 41B are densely arranged clockwise into a reverse triangular shape (∇ shape); and a disposition in which the LED 41R, the LED 41G, and the LED 41B are densely arranged clockwise into a triangular shape (Δ shape).

And, there is a difference among: a brightness distribution of the partial light PL1 generated by a group of the LEDs 41 in which the LED 41G, the LED 41B, and the LED 41R are densely arranged clockwise into the triangular shape (Δ shape); a brightness distribution of the partial light PL2 generated by a group of the LEDs 41 in which the LED 41R, the LED 41G, and the LED 41B are densely arranged clockwise in the reverse triangular shape (∇ shape); and a brightness distribution of the partial light PL3 generated by a group of the LEDs 41 in which the LED 41R, the LED 41G, and the LED 41B are densely arranged clockwise in the triangular shape (Δ shape).

Here, the difference among the brightness distributions is considered. In other words, there is a difference among: a brightness distribution filter FT-G1 corresponding to the brightness adjustment data VD-Sd [A] for the LED 41 group for generating the partial light PL1 shown in FIG. 15B; a brightness distribution filter FT-G2 corresponding to the brightness adjustment data VD-Sd [A] for the LED 41 group for generating the partial light PL2 shown in FIG. 15C; and a brightness distribution filter FT-G3 corresponding to the brightness adjustment data VD-Sd [A] for the LED 41 group for generating the partial light PL3 shown in FIG. 15D (here, in the brightness distribution filters FT-G1 to FT-G3, the reference positions BD are different from one another in accordance with the positions of the LED 41G).

And, as shown in FIG. 15E, the brightness distribution filter FT-G1, the brightness distribution filter FT-G2, and the brightness distribution filter FT-G3 different from one another are used to generate the brightness distribution data VD-Sd [AF] of the backlight BL. In accordance with the difference among the pieces of partial light PL (PL1 to PL3) due to the disposition of the three LEDs (the LED 41R, the LED 41G, and the LED 41B), the brightness distribution data VD-Sd [AF] is generated by means of the plurality of the brightness distribution filters FT (FT-G1 to FT-G3).

Because of this, the brightness distribution data VD-Sd [AF] in the example 5 becomes exact data that reflects interference and the like of each piece of the partial light PL like in the examples 1 to 4. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the examples 1 to 4 and the difference among the dispositions of the three color LEDs 41 (the LED 41R, the LED 41G, and the LED 41B) are combined with each other. However, even in any combination, if the brightness distribution filter FT corresponding to the difference among the brightness distributions of the partial light PL is used, the accuracy of the brightness distribution data VD-Sd [AF] improves.

### Embodiment 2

An embodiment 2 is described. Here, members having the same function as those in the embodiment 1 are indicated by the same reference numbers and description of them is skipped.

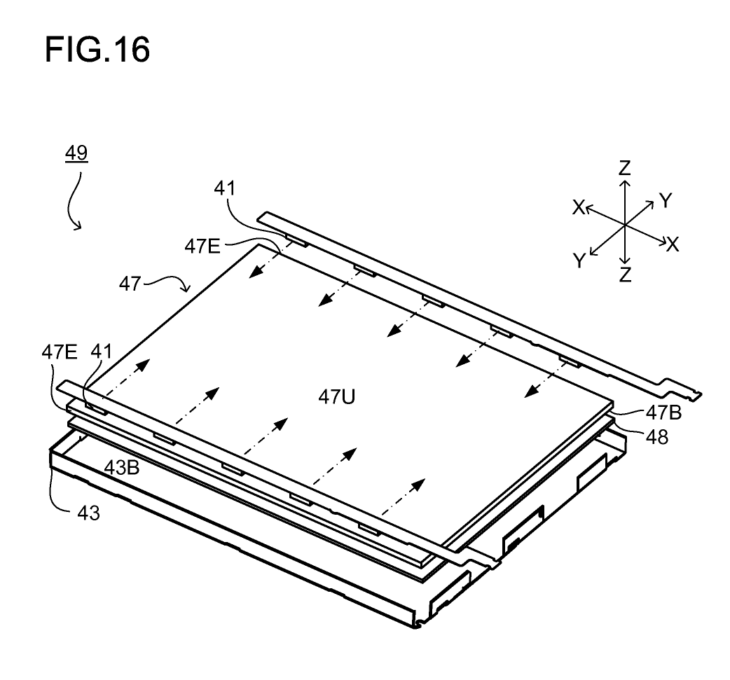

In the embodiment 1, as shown in FIG. 16, at the mount board 42 on the backlight chassis 43 included in the backlight unit 49, the light from the LEDs 41 disposed in the grating shape mixes, whereby the surface light is generated (such backlight unit 49 is called a direct type of backlight unit 49). However, there are many other kinds of the backlight units 49.

For example, as shown in an exploded perspective view of FIG. 16, there also is the backlight unit 49 that uses one light guide plate 47. Describing in detail, in this backlight unit 49, a plurality of the LEDs 41 are disposed along opposite side surfaces 47E of the light guide plate 47; the light from the LEDs 41 enters the side surfaces 47E of the light guide plate 47. And, the light entering the side surfaces 47E undergoes multiple reflection in an inside of the light guide plate 47 and exits as the surface light BL from a ceiling surface 47U of the light guide plate 47 (here, on a bottom surface 47B of the light guide plate 47, a reflection sheet 48 for reflecting light leaking to outside of the light guide plate 47 back into the inside of the light guide plate 47 is disposed). Here, the liquid crystal display device 69 incorporating such backlight unit 49 is defined as an example 6.

### Example 6

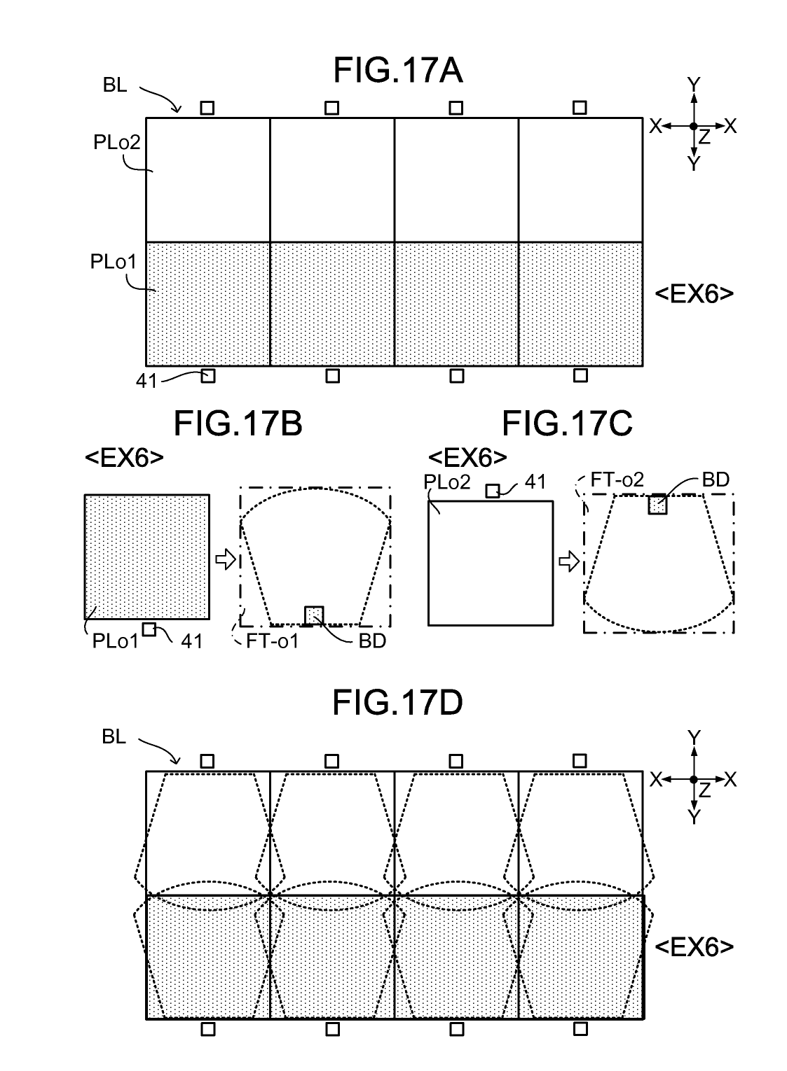

In the liquid crystal display device 69 as the example 6, the backlight BL viewed from the ceiling surface 47U of the light guide plate 47 is shown in FIG. 17A. Here, for example, the partial light PL is set in accordance with four LEDs 41 disposed in parallel and the number of four LEDs 41 which oppose the four LEDs 41 and are disposed in parallel (the 4×2 partial light PL mixes, whereby the backlight BL is generated).

In this example 6, a difference in brightness distribution of the partial light PL due to the LED 41 is a difference in output direction of the light from the LEDs 41 which are in an opposite relationship (in short, the light from the LEDs 41 is opposite to each other; see a one-dot-one-bar line in FIG. 16). And, because of such difference, a brightness distribution of partial light PLo1 generated by the LEDs 41 which output the light in one direction in the opposite relationship and a brightness distribution of partial light PLo2 generated by the LEDs 41 which output the light in the other direction in the opposite relationship are different from each other, accordingly, the difference between the brightness distributions is considered.

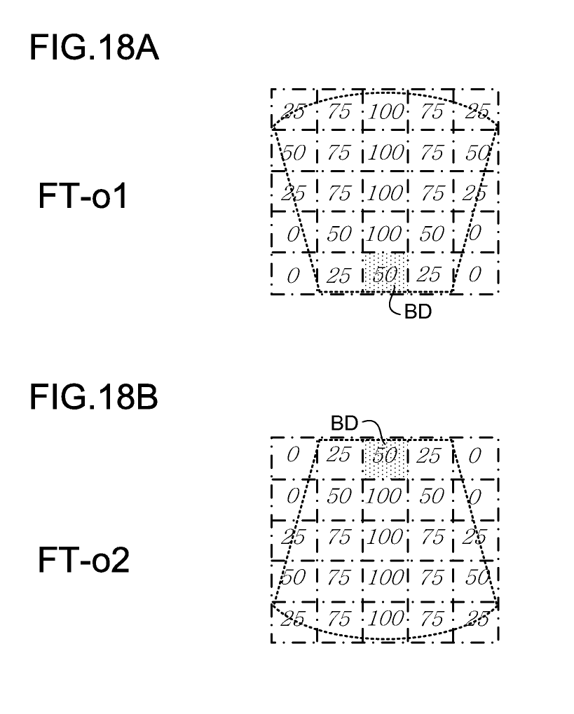

Specifically, a brightness distribution filter FT-o1 corresponding to the brightness adjustment data VD-Sd [A] for the LED 41 for generating the partial light PLo1 shown in FIG. 17B is different from a brightness distribution filter FT-o2 corresponding to the brightness adjustment data VD-Sd [A] for the LED 41 for generating the partial light PLo2 shown in FIG. 17C (here, the brightness distribution filter FT-o1 and the brightness distribution filter FT-o2, whose specific numerical examples of filter values are specified, are shown in FIG. 18A and FIG. 18B).

And, as shown in FIG. 17D, the brightness distribution filter FT-o1 and the brightness distribution filter FT-o2 different from each other are used to generate the brightness distribution data VD-Sd [AF] of the backlight BL. In accordance with the difference between the brightness distributions of the pieces of the partial light PL (PLo1, PLo2) due to the output directions of the LEDs 41, the brightness distribution data VD-Sd [AF] is generated by means of the plurality of the brightness distribution filters FT (FT-o1, FT-o2).

Because of this, the brightness distribution data VD-Sd [AF] in the example 6 becomes exact data that reflects interference and the like of each piece of the partial light PL like in the examples 1 to 5. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the examples 1 to 5 and the difference between the output directions of the LEDs 41 in the example 6 are combined with each other. However, even in any combination, if the brightness distribution filter FT corresponding to the difference between the brightness distributions of the partial light PL is used, the accuracy of the brightness distribution data VD-Sd [AF] improves.

### Embodiment 3

An embodiment 3 is described. Here, members having the same function as those in the embodiments 1 and 2 are indicated by the same reference numbers and description of them is skipped.

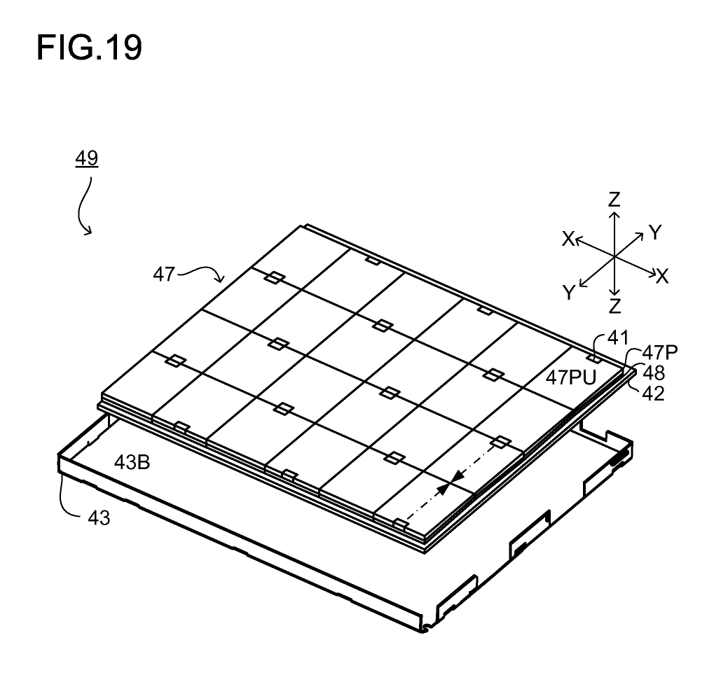

There also is the backlight unit 49 other than the embodiments 1 and 2. For example, as shown in FIG. 19, it is the backlight unit 49 that incorporates a plurality of light guide pieces 47P which are densely disposed in a grating shape (the light guide plate 47 formed of an aggregate of such light guide pieces 47P is called a tandem type of light guide plate 47).

And, in such backlight unit 49, the LED 41 is disposed corresponding to each light guide piece 47P; further, there are two kinds of output directions from the LED 41 (see one-dot-one-bar lines), and those output directions oppose each other. Here, the liquid crystal display device 69 incorporating such backlight unit 49 is defined as an example 7.

### Example 7

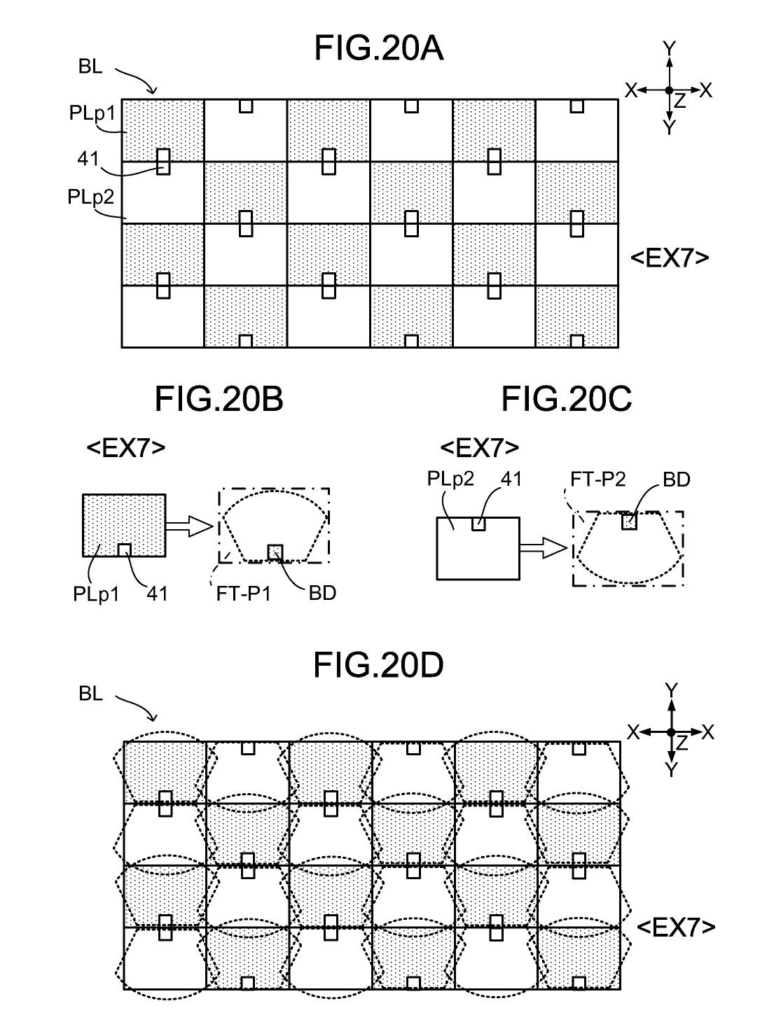

In the liquid crystal display device 69 as the example 7, the backlight BL viewed from a ceiling surface 47PU of the light guide piece 47P disposed in a 6×4 grating is shown in FIG. 20A. Here, for example, the partial light PL is set in a staggered state in accordance with the disposition and number of the light guide pieces 47P (the 6×4 partial light PL mixes, whereby the backlight BL is generated).

In this example 7, a difference in brightness distribution of the partial light PL due to the LED 41 is a difference in output direction of the light from the LEDs 41. And, because of such difference, a brightness distribution of partial light PLp1 generated by the LEDs 41 which output the light in one direction in the opposite relationship and a brightness distribution of partial light PLp2 generated by the LEDs 41 which output the light in the other direction in the opposite relationship are different from each other, accordingly, the difference between the brightness distributions is considered.

In other words, a brightness distribution filter FT-P1 corresponding to the brightness adjustment data VD-Sd [A] for the LED 41 for generating the partial light PLp1 shown in FIG. 20B is different from a brightness distribution filter FT-P2 corresponding to the brightness adjustment data VD-Sd [A] for the LED 41 that generates the partial light PLp2 shown in FIG. 20C.

And, as shown in FIG. 20D, the brightness distribution filter FT-P1 and the brightness distribution filter FT-P2 different from each other are used to generate the brightness distribution data VD-Sd [AF] of the backlight BL. In accordance with the difference between the brightness distributions of the pieces of the partial light PL (PLp1, PLp2) due to the output directions of the LEDs 41, the brightness distribution data VD-Sd [AF] is generated by means of the plurality of the brightness distribution filters FT (FT-P1, FT-P2).

Because of this, the brightness distribution data VD-Sd [AF] in the example 7 becomes exact data that reflects interference and the like of each piece of the partial light PL like in the examples 1 to 6. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the examples 1 to 6 and the difference between the output directions of the LEDs 41 in the example 7 are combined with each other. However, even in any combination, if the brightness distribution filter FT corresponding to the difference between the brightness distributions of the partial light PL is used, the accuracy of the brightness distribution data VD-Sd [AF] improves.

### Embodiment 4

An embodiment 4 is described. Here, members having the same function as those in the embodiments 1 to 3 are indicated by the same reference numbers and description of them is skipped.

In the embodiments 1 to 3, the plurality of pieces of the partial light PL include the partial light PL that have the brightness distributions different from each another. And, considering the difference between the brightness distributions of the partial light PL, the brightness distribution data VD-Sd [AF] is generated by means of the plurality of the brightness distribution filters FT. However, using the plurality of the brightness distribution filters FT is not always due to the difference between the brightness distributions of the partial light PL.

For example, there is a case where even in the backlight unit 49 that emits the backlight BL mixed with the partial light PL which has the same brightness distribution, a plurality of the brightness distribution filters FT are used. Here, the liquid crystal display device 69 incorporating such backlight unit 49 is defined as an example 8.

### Example 8

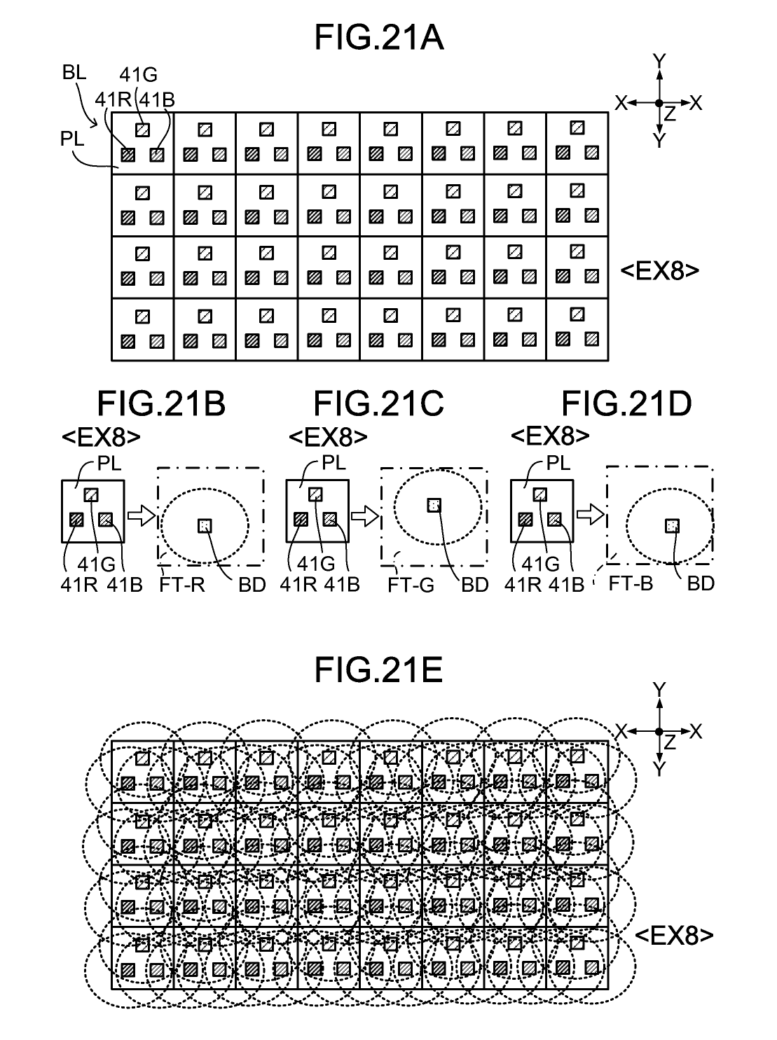

In the liquid crystal display device 69 as the example 8, the backlight BL is shown in FIG. 21A. Here, 8×4 partial light PL mixes, whereby the backlight BL is set.

And, thanks to mixing of the light from the red-light emitting LEDs 41R, the green-light emitting LEDs 41G, and the blue-light emitting LEDs 41B which are disposed by a predetermined distance away from one another not to be regardable as one point light source, each piece of the partial light PL is generated. Especially, the LEDs 41 (41R, 41G, and 41B) are densely arranged in a triangular shape (Δ shape), and the LED 41G, the LED 41B, and the LED 41R are arranged clockwise in this order. Because of this, the brightness distributions of the respective pieces of the partial light PL become the same as one another.

However, the distance between the LEDs 41 (41R, 41G, and 41B) is relatively wide, accordingly, if the same brightness distribution filter FT is used for the brightness adjustment data VD-Sd [A] for the three LEDs 41, the brightness distribution of each piece of the partial light PL does not become exact, and, the brightness distribution data VD-Sd [AF] does not become exact.

Here, there is a difference among: a brightness distribution filter FT-R corresponding to the brightness adjustment data VD-Sd [A] for the LED 41R of the three LEDs 41 (41R, 41G, and 41B) shown in FIG. 21B; a brightness distribution filter FT-G corresponding to the brightness adjustment data VD-Sd [A] for the LED 41G shown in FIG. 21C; and a brightness distribution filter FT-B corresponding to the brightness adjustment data VD-Sd [A] for the LED 41B shown in FIG. 21D (here, in the brightness distribution filters FT-R, FT-G and FT-B, the reference positions BD are different from one another in accordance with the positions of the corresponding LEDs 41 (41R, 41G, and 41B)).

And, as shown in FIG. 21E, the brightness distribution filter FT-R, the brightness distribution filter FT-G and the brightness distribution filter FT-B different from one another are used to generate the brightness distribution data VD-Sd [AF] of the backlight BL. In accordance with each of the plurality of the LEDs 41 (41R, 41G, and 41B) for generating the partial light PL, the brightness distribution data VD-Sd [AF] is generated by means of the plurality of the brightness distribution filters FT (FT-R, FT-G, and FT-B) (in short, the brightness distribution of each piece of the partial light PL is exact, and the brightness distribution data VD-Sd [AF] is exact).

Because of this, the brightness distribution data VD-Sd [AF] in the example 8 becomes exact data that reflects interference and the like of each piece of the partial light PL like in the examples 1 to 7. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

Here, it is conceivable that the difference in at least one example of the examples 1 to 4, the difference in at least one example of the examples 6 and 7 and the difference among the respective colors in the example 8 are combined with one another. However, even in any combination, if the brightness distribution filter FT corresponding to the difference between the brightness distributions of the partial light PL is used, the accuracy of the brightness distribution data VD-Sd [AF] improves.

Besides, in the example 8, in accordance with each of the different-color LEDs 41 (41R, 41G, and 41B), the brightness distribution data VD-Sd [AF] is generated by means of the plurality of the brightness distribution filters FT. However, this is not limiting, and for example, in a case where the plurality of the LEDs 41 for generating one piece of the partial light PL have the same color, the brightness distribution data VD-Sd [AF] may be generated, in accordance with each of the LEDs 41, by means of the plurality of the brightness distribution filters FT.

### Embodiment 5

An embodiment 5 is described. Here, members having the same function as those in the embodiments 1 to 4 are indicated by the same reference numbers and description of them is skipped.

For example, during operation of the backlight unit 49, there is case where a change occurs in the inherent brightness distribution of the LED 41 because of at least one of the following (1) to (3):

(1) fault with the LED 41 that emits the light,

(2) adhering matter on the LED 41 that blocks the light, and

(3) temperature rise (rise in junction temperature) of the LED 41 due to the light emission.

And, if a change occurs in the inherent brightness distribution of the LED 41, a difference occurs among a plurality of pieces of the partial light PL that generate the backlight BL. Here, the liquid crystal display device 69, which incorporates the backlight unit 49 that has one faulty LED 41 of a group of the LEDs 41 for generating one piece of the partial light PL, is defined as an example 9.

### Example 9

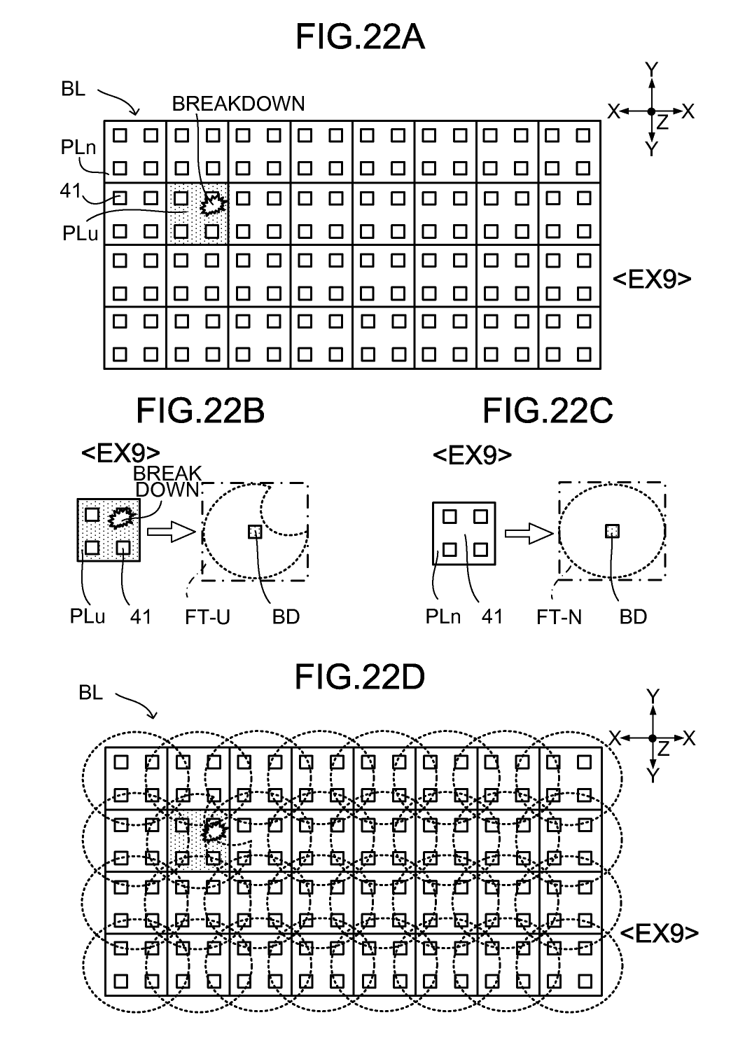

The backlight BL in the example 9, as shown in FIG. 22A, has an aggregate of 8×4 partial light PL, in which a brightness distribution of partial light PLu generated by a group of LEDs 41 including the faulty LED 41 and a brightness distribution of partial light PLn generated by a group of normal LEDs 41 are different from each other, accordingly, the difference between the brightness distributions is considered.

First, the filter process portion 16 of the image control portion 12 uses the photo sensor 34 to measure brightness (brightness distribution) of all the pieces of the partial light PL. And, the filter process portion 16 detects the partial light PLu that has a relatively low brightness due to the fault with the LED 41, further, detects the faulty LED 41 as well from the brightness distribution of the partial light PLu.

And, the filter process portion 16 selects, from the filter memory 16M, a brightness distribution filter FT-U that corresponds to the partial light PLu, and by means of the brightness distribution filter FT-U, processes the brightness adjustment data VD-Sd [A] for the LED 41 that generates the partial light PLu. Besides, the filter process portion 16 selects, from the filter memory 16M, a brightness distribution filter FT-N that corresponds to the partial light PLn, and by means of the brightness distribution filter FT-N, processes the brightness adjustment data VD-Sd [A] for the LED 41 that generates the partial light PLn.

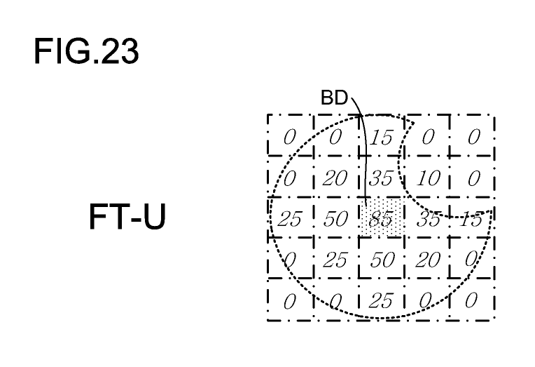

And, the brightness distribution filter FT-U corresponding to the brightness adjustment data VD-Sd [A] for the LED 41 for generating the partial light PLu shown in FIG. 22B is different from the brightness distribution filter FT-N corresponding to the brightness adjustment data VD-Sd [A] for the LED 41 for generating the partial light PLn shown in FIG. 22C (here, the brightness distribution filter FT-U, whose specific numerical examples of filter values are specified, is shown in FIG. 23).

And, as shown in FIG. 22D, the brightness distribution filter FT-U and the brightness distribution filter FT-N different from each other are used to generate the brightness distribution data VD-Sd [AF] of the backlight BL. In accordance with the difference between the brightness distributions of the pieces of the partial light PL (PLu, PLn) due to the output directions of the LEDs 41, the brightness distribution data VD-Sd [AF] is generated by means of the plurality of the brightness distribution filters FT (FT-U, FT-N).

Because of this, the brightness distribution data VD-Sd [AF] in the example 9 becomes exact data that reflects interference and the like of each piece of the partial light PL like in the examples 1 to 8. Further, the correspondence between the correction panel control data VD-Sp [d], which is the panel control data VD-Sp corrected by means of the brightness distribution data VD-Sd [AF], and the brightness adjustment data VD-Sd [A] becomes highly accurate. As a result of this, the quality of the display image on the liquid crystal display device 69 improves.

In other words, in the liquid crystal display device 69 that is continuously driven, even if part of the LEDs 41 are faulty, the correspondence between the brightness adjustment data VD-Sd [A] and the correction panel control data VD-Sp [d] improves; and the quality of the display image on the liquid crystal display device 69 surely improves.

Here, it is conceivable that the difference in at least one example of the examples 1 to 8and the presence of fault and the like with the LEDs 41 in the example 9 are combined with each other. However, even in any combination, if the brightness distribution filter FT corresponding to the difference between the brightness distributions of the partial light PL is used, the accuracy of the brightness distribution data VD-Sd [AF] improves.

Besides, even if a change occurs in the inherent brightness distribution of the LED 41 and partial light PLu different from the normal partial light PLn is generated because of (2) adhering matter on the LED 41 that blocks the light, or (3) temperature rise of the LED 41 due to the light emission, the partial light PLu is detected by the photo sensor 34.

Besides, in a case where because of (3) temperature rise of the LED 41 due to the light emission, a change occurs in the inherent brightness distribution of the LED 41 and the partial light PLu different from the normal partial light PLn is generated, the partial light PLu is also detected in the temperature measurement by the thermistor 35 shown in FIG. 1 by the photo sensor 34 (in short, not only by the photo sensor 34, it is also possible to confirm the generation of the partial light PL by the thermistor 35 as well, and in accordance with the difference between the brightness distributions of the partial light PL (Plu, Pln), the brightness distribution data VD-Sd [AF] is generated by means of the plurality of the brightness distribution filters FT (FT-U, FT-N).

### Other Embodiments

Here, the present invention is not limited to the above embodiments, and various modifications are possible without departing from the spirit of the present invention.

In the above description, the LED 41RGB of three color mixed type is described as an example, which as the single LED 41, includes three color (red, green, and blue) LED chips, and generates the white light by means of the mixing of the red light, the green light and the blue light; and the LED 41E of fluorescent-light emitting type is described as an example, which includes the blue-light emitting LED chip and the fluorescent body that receives the light from the LED chip to emit the yellow fluorescent light, and mixes the light from the blue-light emitting LED chip and the yellow fluorescent light with each other to generate the white light. However, the kind of the LED 41 is not limited to these.

Even the LEDs 41RGB of three color mixed type include: a type which is capable of emitting the white light only; and a type which is capable of emitting not only the white light but also light obtained by mixing the red light, the green light and the blue light or light obtained by mixing two colors of the three colors.

Besides, the LED 41 of fluorescent-light emitting type may be a type which includes a blue-light emitting LED chip and a fluorescent body that receives light from the LED chip to emit green fluorescent light and red fluorescent light, and generates the white light by means of the blue light from the LED chip and the fluorescent light (green light, red light).

Besides, the LED 41 of fluorescent-light emitting type may be a type which includes: a red LED chip that emits red light, a blue LED chip that emits blue light, and a fluorescent body that receives light from the blue LED chip to emit green fluorescent light; and generates the white light by means of the red light and blue light from the LED chips and the green fluorescent light.

In other words, there are various types of the LEDs 41. And, there is an inherent brightness distribution for each type, accordingly, there are many kinds of the brightness distributions of the partial light PL generated by the light from the LEDs 41. However, like in the above-described liquid crystal display device 69, if the brightness distribution filter FT corresponding to the difference between the brightness distributions of the partial light PL is used, the accuracy of the brightness distribution data VD-Sd [AF] improves.

As a result of this, the correspondence between the correction panel control data VD-Sp [d] corrected by means of the brightness distribution data VD-Sd [AF] and the brightness adjustment data VD-Sd [A] becomes highly accurate; and the quality of the display image on the liquid crystal display device 69 improves.

Here, in the above description, as the point light source, the LED 41 which is a light emitting element is described as an example; however, this is not limiting. For example, a light emitting element like a laser element may be used, or a light emitting element, which is formed of a self-light emitting material such as organic EL (Electro-Luminescence), inorganic EL or the like, may be used.

### REFERENCE SIGNS LIST

11 control unit
12 image control portion
13 image data process portion
14 timing control portion
15 brightness adjustment data generation portion
16 filter process portion
16M filter memory
17 panel control data correction portion
21 LCD controller
22 LED controller
23 LED driver control portion
24 pulse width modulation portion
31 gate driver
32 source driver
33 LED driver
34 photo sensor (brightness measurement portion)
35 thermistor (temperature measurement portion)
41 LED (light source, light emitting element, point light source)
42 mount board
49 backlight unit (illumination device)
BL backlight (output light from illumination device)
PL partial light (partial light included in output light)
59 liquid crystal display panel (display panel)
69 liquid crystal display device (display device)

1. A display device comprising:
an illumination device that generates output light by mixing light source light from a plurality of light sources;
a display panel that receives the output light;
a control unit that controls the illumination device and the display panel;
the control unit includes:
an image data process portion that obtains image data and generates, from the image data, light source control data and panel control data;
a light-amount adjustment data generation portion that processes the light source control data in accordance with each piece of partial light, that is, local light included in the output light so as to generate brightness adjustment data for controlling brightness of the light source;
a filter process portion that processes each of the brightness adjustment data that corresponds to the pieces of the partial light by means of one of a plurality of brightness distribution filters so as to generate brightness distribution data of the output light, there are many kinds of brightness distributions of the plurality of the pieces of the partial light due to the light source; and
a panel control data correction portion that from the brightness distribution data and the panel control data, generates correction panel control data controlling a display image on the display panel.

2. The display device according to claim 1, wherein that there are many kinds of brightness distributions of the plurality of pieces of partial light due to the light source means that a plurality of the light sources having different inherent brightness distributions are included, whereby there are many kinds of the brightness distributions of the plurality of pieces of partial light.

3. The display device according to claim 2, wherein the inherent brightness distribution differs depending on whether the light source is a power light emitting element or not.

4. The display device according to claim 2, wherein the inherent brightness distribution depends on whether the light source emits white light obtained by mixing light from a plurality of incorporated light emitting chips that emit single color light or emits white light obtained by mixing the light from the incorporated light emitting chip and light from a fluorescent-light emitting body that receives the light from the light emitting chip to emit fluorescent light.

5. The display device according to claim 1, wherein that there are many kinds of brightness distributions of the plurality pieces of partial light due to the light source means that there is a difference in light-source density of the plurality of light sources, whereby there are the many kinds of brightness distributions of the plurality of pieces of partial light.

6. The display device according to claim 1, wherein that there are many kinds of brightness distributions of the plurality pieces of partial light due to the light source means that the plurality of light sources emitting the single light mix the light source light so as to generate the partial light of the white light and there are many kinds of distributions of the light source emitting the partial light, whereby there are the many kinds of the brightness distributions of the plurality of pieces of partial light.

7. The display device according to claim 1, wherein that there are many kinds of brightness distributions of the plurality pieces of partial light due to the light source means that the plurality of light sources include light sources that are different from one another in output direction of the light source light, whereby there are many kinds of the brightness distributions of the plurality of pieces of partial light.

8. The display device according to claim 1, wherein a brightness measurement portion for measuring the brightness of the light source light is included, and in a case where a change occurs in the brightness distribution of the partial light because of at least one of:
(1) fault with the light source that emits the light source light,
(2) adhering matter on the light source that blocks the light source light, and
(3) temperature rise of the light source due to the light emission,
the panel control data correction portion selects a correction filter in accordance with a measurement result from the brightness measurement portion.

9. A display device comprising:
an illumination device that generates output light by mixing light source light from a plurality of light sources;
a display panel that receives the output light;
a control unit that controls the illumination device and the display panel;
the control unit includes:
an image data process portion that obtains image data and generates, from the image data, light source control data and panel control data;
a light-amount adjustment data generation portion that processes the light source control data in accordance with each piece of partial light, that is, local light included in the output light so as to generate brightness adjustment data for controlling brightness of the light source;
a filter process portion that processes the brightness adjustment data corresponds to each of the plurality of light sources that generate the partial light by means of a different brightness distribution filter so as to generate brightness distribution data of the output light; and
a panel control data correction portion that from the brightness distribution data and the panel control data, generates correction panel control data controlling a display image on the display panel.

10. The display device according to claim 9, wherein the plurality of light sources that generate the partial light include a red-light emitting light source, a green-light emitting light source, and a blue-light emitting light source.

11. The display device according to claim 9, wherein a brightness measurement portion that measures the brightness of the light source light is included, and in a case where a change occurs in the brightness distribution of the partial light because of at least one of:
(1) fault with the light source that emits the light source light,
(2) adhering matter on the light source that blocks the light source light, and
(3) temperature rise of the light source due to the light emission,
the panel control data correction portion selects a correction filter in accordance with a measurement result from the brightness measurement portion.
